(19) United States
(12) Patent Application Publication
(10) Pub. No.: US 2026/0316275 A1
(43) Pub. Date: Oct. 15, 2026

(54) SYSTEMS AND METHODS FOR MODULATING SPEED LIMITS OF ROBOTIC DEVICES

(71) Applicant: Brain Corporation, San Diego, CA (US)

(72) Inventors: Micah RICHERT, San Diego, CA (US); Gaurav SHARMA, San Diego, CA (US); Sahil Rajesh DHAYALKAR, San Diego, CA (US)

(73) Assignee: Brain Corporation, San Diego, CA (US)

(21) Appl. No.: 19/709,539

(22) Filed: Jun. 16, 2026

Related U.S. Application Data
(63) Continuation of application No. PCT/US2025/011194, filed on Jan. 10, 2025.
(60) Provisional application No. 63/619,957, filed on Jan. 11, 2024.

(51) Int. Cl. B25J 9/16; B25J 13/08

(52) U.S. Cl. CPC B25J 9/1666; B25J 9/1651; B25J 9/1697; B25J 13/089

(57) ABSTRACT

Systems and methods for modulating speed limits of robotic devices are disclosed herein. According to at least one non-limiting exemplary embodiment, a robot may calculate a maximum speed limit as a function of available turn partitions, or set of discretized movements, and distance to nearest obstacles along the turn partitions. The system determines, for each of several turn partitions, the distance to the nearest obstacle point within each partition. It identifies a turn partition to execute based on a segment of the robot's route, which includes a turn within the partition's range. The system calculates a speed limit for the robot on this route segment, considering the distance to the nearest obstacle in the selected turn partition, and assigns a maximum speed to the robot according to the determined speed limit. This approach optimizes the robot's navigation by dynamically adjusting speed based on environmental obstacles and route requirements.

### CROSS-REFERENCE TO RELATED APPLICATION(S)

This application is a national stage application of International Application No. PCT/US2025/011194, filed Jan. 10, 2025, which claims the benefit of U.S. Provisional Application No. 63/619,957, filed Jan. 11, 2024, and any other applications identified in the Application Data Sheet, the disclosures of which are incorporated herein by reference in their entireties.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

### Technological Field

The present application relates generally to robotics, and more specifically to systems and methods modulating speed limits for robotic devices.

In the field of robotics, navigation systems have traditionally relied on pre-defined maps and static obstacle detection to guide robots through their environments. These systems often use a combination of sensors such as LIDAR, cameras, and ultrasonic sensors to detect obstacles and navigate around them. However, these approaches typically involve complex algorithms that require significant computational resources to process sensor data in real-time. Additionally, the static nature of pre-defined maps can limit the robot's ability to adapt to dynamic environments where obstacles may move or change over time.

Another approach involves the use of reactive navigation systems, which focus on real-time obstacle avoidance without relying on pre-defined maps. These systems use sensor data to make immediate decisions about the robot's path, often employing techniques such as potential fields or vector fields to navigate around obstacles. While reactive systems can be effective in dynamic environments, they may struggle with planning optimal routes over longer distances or in complex environments with multiple obstacles. Furthermore, these systems may not always account for the robot's speed or the optimal speed for navigating around obstacles, which can lead to inefficient or unsafe navigation.

Hybrid navigation systems have also been developed, combining elements of both pre-defined map-based navigation and reactive obstacle avoidance. These systems aim to leverage the strengths of both approaches, using maps for long-term planning and real-time sensor data for immediate obstacle avoidance. However, integrating these two approaches can be challenging, as it requires balancing the computational demands of processing sensor data with the need for efficient route planning. Additionally, determining appropriate speed limits for navigating around obstacles remains a complex task, as it involves assessing the proximity of obstacles and the robot's current trajectory.

However, none of these approaches have provided a comprehensive solution that combines the features described in this disclosure.

### SUMMARY

The foregoing needs are satisfied by the present disclosure, which provides for, inter alia, systems and methods modulating speed limits for robotic devices.

Exemplary embodiments described herein have innovative features, no single one of which is indispensable or solely responsible for their desirable attributes. Without limiting the scope of the claims, some of the advantageous features will now be summarized. One skilled in the art would appreciate that as used herein, the term robot may generally be referred to autonomous vehicle or object that travels a route, executes a task, or otherwise moves automatically upon executing or processing computer readable instructions.

According to at least one non-limiting exemplary embodiment, a robotic system is disclosed. The robotic system comprises: A robotic system, comprising: one or more robots; a non-transitory computer readable storage medium comprising computer readable instructions stored thereon; and a controller configured to execute the computer readable instructions and cause at least one of the one or more robots to: receive sensor data from a plurality of sensors, the sensor data comprising a plurality of points corresponding to obstacles in an environment of the robotic system; determine, for each turn partition of a plurality of turn partitions, a distance to a nearest point of each of one or more obstacles located in each respective turn partition; determine a turn partition of the plurality of turn partitions to execute in accordance with a portion of a route for the at least one robot to follow, wherein the portion of the route comprises a turn within a range corresponding to the turn partition; determine a speed limit for the at least one robot for the portion of the route based on the distance to the nearest point of each of the one or more obstacles located in the selected turn partition; and assign a maximum speed of the at least one robot based on a corresponding speed limit of the selected turn partition.

According to at least one non-limiting exemplary embodiment, each turn partition comprises a plurality of discretized motions the at least one robot performs when navigating the environment according to the respective turn partition.

According to at least one non-limiting exemplary embodiment, upon determining the nearest point of each of the one or more obstacles, the controller is further configured to execute the computer readable instructions and cause the at least one robot to: determine a nearest LiDAR point of each of the one or more obstacles with respect to a virtual LiDAR, the virtual LiDAR comprising an origin point from which ranges to the plurality of points measured by the plurality of sensors are defined with respect to, wherein each nearest LiDAR point comprises an angle defined about the origin point; and extend each nearest LiDAR point by a threshold angular distance in both a clockwise and a counterclockwise direction from the origin point of the virtual LiDAR to generate a nearest point arc for each nearest LiDAR point, wherein each nearest point arc comprises a plurality of points.

According to at least one non-limiting exemplary embodiment, upon determining the nearest point of the obstacles, the controller is further configured to execute the computer readable instructions and cause the at least one robot to: exclude at least a portion of the plurality of points of one or more of the nearest point arcs corresponding to points that are behind other nearest point arcs with respect to the origin point.

According to at least one non-limiting exemplary embodiment, upon determining the speed limit, the controller is further configured to execute the computer readable instructions and cause the at least one robot to: discretize the route into a plurality of sequential route sections, wherein each route section corresponds to a different turn partition of the plurality of turn partitions from a prior route section; determine a speed limit for each route section based on the distance to the nearest point of one or more objects in each route section; interpolate the speed limits for each route section between each point along the designated route to determine a speed limit as a function of distance along the route; and navigate at or below the speed limit as a function of distance along the route.

According to at least one non-limiting exemplary embodiment, wherein the maximum speed of the at least one robot is less than a threshold speed.

According to at least one non-limiting exemplary embodiment, upon assigning the maximum speed, the controller is further configured to execute the computer readable instructions and cause the at least one robot to: evaluate two or more speed limits with respect to two or more different modes of stopping the at least one robot, wherein the different modes of stopping correspond to different stopping distances.

According to at least one non-limiting exemplary embodiment, a non-transitory computer readable medium comprising instructions stored thereon, when executed by one or more controllers of a robotic system, cause at least one robot of the robotic system to perform one or more of the preceding steps.

According to at least one non-limiting exemplary embodiment, a method for maneuvering a robotic system executes one or more of the preceding steps.

According to at least one non-limiting exemplary embodiment, a method for determining and applying speed limits for a robot navigating a route is disclosed. The method comprising, segmenting, by a controller, the route into a plurality of route segments based points along the route where a turning angle of the robot changes between predefined turn partition ranges; calculating, by the controller, speed limits for each route segment of the plurality of route segments based on a proximity of the robot to objects within an angular range of a turn partition corresponding to each route segment; assigning, by the controller, the calculated speed limits to the points along the route; and applying, by the controller, a fitting function connecting the points along the route to yield a continuous maximum speed limit as a function of a position of the robot along the route.

Wherein each point along the route corresponds to a start of a respective route segment, and wherein each route segment includes the robot navigating within only one turn partition. Further, wherein the objects pose a risk of collision with the robot, thereby affecting the calculated speed limits. Wherein, the fitting function is a quadratic best fit curve. The predefined turn partition ranges gradually increase as a function of larger turning angles; and wherein the predefined turn partition ranges are configured such that there are substantially more turn partitions closer to 0° with smaller angular ranges and fewer turn partitions closer to 90° with larger angular ranges.

Additionally, wherein the controller changes from a first turn partition to a different second turn partition to navigate different route segments. And, wherein, the robot determines the maximum speed limit to navigate safely along the route.

These and other objects, features, and characteristics of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure. As used in the specification and in the claims, the singular form of “a”, “an”, and “the” include plural referents unless the context clearly dictates otherwise.

In some aspects, the techniques described herein relate to a system, including: a memory including computer readable instructions stored thereon; and a controller configured to execute the computer readable instructions to: receive data from a plurality of sensors coupled to a robot, the data including a plurality of points corresponding to obstacles in an environment of the robot; determine, for each turn partition of a plurality of turn partitions, a distance to a nearest point of each of one or more obstacles located in each respective turn partition; determine a turn partition of the plurality of turn partitions to execute in accordance with a portion of a route for the robot to follow, wherein the portion of the route includes a turn within a range corresponding to the turn partition; determine a speed limit for the robot for the portion of the route based on the distance to the nearest point of each of the one or more obstacles located in the turn partition; and assign a maximum speed to the robot based on a corresponding speed limit of the turn partition.

In some aspects, the techniques described herein relate to a system, wherein each turn partition includes a plurality of discretized motions that the robot performs when navigating the environment according to a respective turn partition.

In some aspects, the techniques described herein relate to a system, wherein, upon determining the nearest point of each of the one or more obstacles, the controller is further configured to execute the computer readable instructions to: determine a nearest LiDAR point of each of the one or more obstacles with respect to a virtual LiDAR, the virtual LiDAR including an origin point from which ranges to the plurality of points measured by the plurality of sensors are defined with respect to, wherein each nearest LiDAR point includes an angle defined about the origin point; and extend each nearest LiDAR point by a threshold angular distance in both a clockwise and a counterclockwise direction from the origin point of the virtual LiDAR to generate a nearest point arc for each nearest LiDAR point, wherein each nearest point arc includes a plurality of points.

In some aspects, the techniques described herein relate to a system, wherein, upon determining the nearest point of the obstacles, the controller is further configured to execute the computer readable instructions to: exclude at least a portion of the plurality of points of one or more of the nearest point arcs corresponding to points that are behind other nearest point arcs with respect to the origin point.

In some aspects, the techniques described herein relate to a system, wherein, upon determining the speed limit, the controller is further configured to execute the computer readable instructions to: discretize the route into a plurality of sequential route sections, wherein each route section corresponds to a different turn partition of the plurality of turn partitions from a prior route section; determine a speed limit for each route section based on the distance to the nearest point of one or more objects in each route section; interpolate the speed limit for each route section between each point along a designated route to determine a speed limit as a function of distance along the route; and navigate at or below the speed limit as a function of distance along the route.

In some aspects, the techniques described herein relate to a system, wherein the maximum speed of the robot is less than a threshold speed.

In some aspects, the techniques described herein relate to a system, wherein, upon assigning the maximum speed, the controller is further configured to execute the computer readable instructions to: evaluate two or more speed limits with respect to two or more different modes of stopping the robot, wherein different modes of stopping correspond to different stopping distances, and adjusting speed limits of the robot in real-time based on new objects identified along the route traveled by the robot, the new objects not being pre-loaded onto a computer readable map of the environment, the computer readable map being uploaded onto the robot prior to navigation of the robot along the route.

In some aspects, the techniques described herein relate to a method of a maneuvering a robot, including: receiving, by a controller coupled to a robot, data from a plurality of sensors, the data including a plurality of points corresponding to obstacles in an environment of the robot; determining, by the controller, for each turn partition of a plurality of turn partitions, a distance to a nearest point of the obstacles located in each respective turn partition; determining, by the controller, a turn partition of the plurality of turn partitions to execute in accordance with a portion of a route for the at least one robot to follow, wherein the portion of the route includes a turn within a range corresponding to the turn partition; determining, by the controller, a speed limit for the robot for the portion of the route based on the distance to the nearest point of each of the obstacles located in the turn partition; and assigning, by controller, a maximum speed of the robot based on a corresponding speed limit of the turn partition.

In some aspects, the techniques described herein relate to a method, wherein each turn partition includes a plurality of discretized motions the robot performs when navigating the environment according to the respective turn partition.

In some aspects, the techniques described herein relate to a method, further including: determining, by the controller, a nearest LiDAR point of each of the obstacles with respect to a virtual LiDAR, the virtual LiDAR including an origin point from which ranges to the plurality of points measured by the plurality of sensors are defined with respect to, wherein each nearest LiDAR point includes an angle defined about the origin point; and extending, by the robot, each nearest LiDAR point by a threshold angular distance in both a clockwise and a counterclockwise direction from the origin point of the virtual LiDAR to generate a nearest point arc for each nearest LiDAR, wherein each nearest point arc includes a plurality of points.

In some aspects, the techniques described herein relate to a method, further including: excluding at least a portion of the plurality of points of one or more of the nearest point arcs corresponding to points that are behind other nearest point arcs with respect to the origin point.

In some aspects, the techniques described herein relate to a method, further including: discretizing, by the controller, the route into a plurality of sequential route sections, wherein each route section corresponds to a different turn partition of the plurality of turn partitions from a prior route section; determining, by the controller, a speed limit for each route section based on the distance to the nearest point of one or more objects in each route section; interpolating, by the controller, the speed limits for each route section between each point along the designated route to determine a speed limit as a function of distance along the route; and navigating, by the controller, at or below the speed limit as a function of distance along the route.

In some aspects, the techniques described herein relate to a method, wherein the maximum speed of the robot is less than a threshold speed.

In some aspects, the techniques described herein relate to a method, further including: evaluating, by the controller, two or more speed limits with respect to two or more different modes of stopping the robot, wherein the different modes of stopping correspond to different stopping distances; and adjusting speed limits of the robot in real-time based on new objects identified along the route traveled by the robot, the new objects not being pre-loaded onto a computer readable map of the environment, the computer readable map being uploaded onto the robot prior to navigation of the robot along the route.

In some aspects, the techniques described herein relate to a non-transitory computer readable storage medium including computer readable instructions stored thereon that, when executed by one or more controllers of a robotic system, cause at least one robot of the robotic system to: receive sensor data from a plurality of sensors, the sensor data including a plurality of points corresponding to obstacles in an environment of the robotic system; determine, for each turn partition of a plurality of turn partitions, a distance to a nearest point of each of one or more obstacles located in each respective turn partition; determine a turn partition of the plurality of turn partitions to execute in accordance with a portion of a route for the at least one robot to follow, wherein the portion of the route includes a turn within a range corresponding to the turn partition; determine a speed limit for the at least one robot for the portion of the route based on the distance to the nearest point of each of the one or more obstacles located in the selected turn partition; and assign a maximum speed of the at least one robot based on a corresponding speed limit of the selected turn partition.

In some aspects, the techniques described herein relate to a non-transitory computer readable storage medium, wherein each turn partition includes a plurality of discretized motions the at least one robot performs when navigating the environment according to the respective turn partition.

In some aspects, the techniques described herein relate to a non-transitory computer readable storage medium, wherein the computer readable instructions further cause at least one robot of the robotic system to: determine a nearest LiDAR point of each of the one or more obstacles with respect to a virtual LiDAR, the virtual LiDAR including an origin point from which ranges to the plurality of points measured by the plurality of sensors are defined with respect to, wherein each nearest LiDAR point includes an angle defined about the origin point; and extend each nearest LiDAR point by a threshold angular distance in both a clockwise and a counterclockwise direction from the origin point of the virtual LiDAR to generate a nearest point arc for each nearest LiDAR point, wherein each nearest point arc includes a plurality of points.

In some aspects, the techniques described herein relate to a non-transitory computer readable storage medium, wherein the computer readable instructions further cause at least one robot of the robotic system to: exclude at least a portion of the plurality of points of one or more of the nearest point arcs corresponding to points that are behind other nearest point arcs with respect to the origin point.

In some aspects, the techniques described herein relate to a non-transitory computer readable storage medium, wherein the computer readable instructions further cause at least one robot of the robotic system to: discretize the route into a plurality of sequential route sections, wherein each route section corresponds to a different turn partition of the plurality of turn partitions from a prior route section; determine a speed limit for each route section based on the distance to the nearest point of one or more objects in each route section; interpolate the speed limits for each route section between each point along the designated route to determine a speed limit as a function of distance along the route; and navigate at or below the speed limit as a function of distance along the route.

In some aspects, the techniques described herein relate to a non-transitory computer readable storage medium, wherein the computer readable instructions further cause at least one robot of the robotic system to: evaluate two or more speed limits with respect to two or more different modes of stopping the at least one robot, wherein the different modes of stopping correspond to different stopping distances; and adjusting speed limits of the robot in real-time based on new objects identified along the route traveled by the robot, the new objects not being pre-loaded onto a computer readable map of the environment, the computer readable map being uploaded onto the robot prior to navigation of the robot along the route.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1A is a functional block diagram of a robot in accordance with some embodiments of this disclosure.

FIG. 1B is a functional block diagram of a controller or processor in accordance with some embodiments of this disclosure.

FIGS. 2A-D illustrate a robot executing various maneuvers and modulating its speed limit in accordance with a nearby object, according to an exemplary embodiment.

FIG. 3 is a process flow diagram illustrating a method for determining a speed limit for a robot, according to an exemplary embodiment.

FIG. 4 depicts a robot calculating its speed limit in accordance with nearby objects and a route, according to an exemplary embodiment.

FIG. 5 depicts a robot at various distances to an object modulating its speed limit for all possible turn partitions, according to an exemplary embodiment.

FIG. 6 is a graph of a speed limit as a function of distance to an object, according to an exemplary embodiment.

FIG. 7A is a functional block diagram of a system combining a current turn partition and distances to nearby objects to produce a speed limit, according to an exemplary embodiment.

FIG. 7B (i-iii) depicts a route and the corresponding turn partitions thereof used to calculate speed limits for multiple sections of the route, according to an exemplary embodiment.

FIG. 8A-B are a three dimensional view of a robot in an environment producing a map thereof and calculating speed limits, according to an exemplary embodiment.

FIG. 9 illustrates, in a flowchart, operations for optimizing robot speed limits along routes, according to an exemplary embodiment.

All Figures disclosed herein are © Copyright 2024-2025 Brain Corporation. All rights reserved.

### DETAILED DESCRIPTION

Currently, robots employ a variety of techniques to ensure they are capable of stopping prior to collisions with objects. Robots may utilize, for example, discrete regions, wherein objects far away have little impact and objects within a threshold range cause a stop. While sufficient to ensure safety, discrete regions often come at the cost of jerking movements or sudden changes in velocity. Further, as discretization increases (i.e., the number of discrete regions increases), computational complexity also increases. To illustrate, a robot which stops when an object is within 5 inches of itself may enforce this rule with far less computation than a robot which has 10 regions progressively further from the robot, each slightly increasing in maximum allowable speed of the robot. Calculating regions around a robot for mapping and path planning functions may further include convolution operations to evaluate future positions of the regions, which are also computationally expensive. Lastly, the minimum distance at which objects may be allowed to pass a robot without causing the robot to stop may change based on the robot type and environment type. Accordingly, there is a need in the art for systems and methods which dynamically modulate a speed limit for a robot which are safe, adaptable, and lightweight in computational complexity.

Various aspects of the systems, apparatuses, and methods disclosed herein are described more fully hereinafter with reference to the accompanying drawings. This disclosure can, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art would appreciate that the scope of the disclosure is intended to cover any aspect of the novel systems, apparatuses, and methods disclosed herein, whether implemented independently of, or combined with, any other aspect of the disclosure. For example, an apparatus may be implemented or a method may be practiced using any number of the aspects set forth herein. In addition, the scope of the disclosure is intended to cover such an apparatus or method that is practiced using other structure, functionality, or structure and functionality in addition to or other than the various aspects of the disclosure set forth herein. It should be understood that any aspect disclosed herein may be implemented by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, and/or objectives. The detailed description and drawings are merely illustrative of the disclosure rather than limiting, the scope of the disclosure being defined by the appended claims and equivalents thereof.

The present disclosure provides for systems and methods modulating speed limits for robotic devices. As used herein, a robot may include mechanical and/or virtual entities configured to carry out a complex series of tasks or actions autonomously. In some exemplary embodiments, robots may be machines that are guided and/or instructed by computer programs and/or electronic circuitry. In some exemplary embodiments, robots may include electro-mechanical components that are configured for navigation, where the robot may move from one location to another. Such robots may include autonomous and/or semi-autonomous cars, floor cleaners, rovers, drones, planes, boats, carts, trams, wheelchairs, industrial equipment, stocking machines, mobile platforms, personal transportation devices (e.g., hover boards, SEGWAYS®, etc.), stocking machines, trailer movers, vehicles, and the like. Robots may also include any autonomous and/or semi-autonomous machine for transporting items, people, animals, cargo, freight, objects, luggage, and/or anything desirable from one location to another.

As used herein, a speed limit refers to the maximum operable speed a robot is permitted to navigate. It is appreciated that a robot may marginally overshoot the speed limit momentarily due to delay in feedback without necessarily requiring to stop.

As used herein, network interfaces may include any signal, data, or software interface with a component, network, or process including, without limitation, those of the FireWire (e.g., FW400, FW800, FWS800T, FWS1600, FWS3200, etc.), universal serial bus (“USB”) (e.g., USB 1.X, USB 2.0, USB 3.0, USB Type-C, etc.), Ethernet (e.g., 10/100, 10/100/1000 (Gigabit Ethernet), 10-Gig-E, etc.), multimedia over coax alliance technology (“MoCA”), Coaxsys (e.g., TVNET™), radio frequency tuner (e.g., in-band or OOB, cable modem, etc.), Wi-Fi (802.11), WiMAX (e.g., WiMAX (802.16)), PAN (e.g., PAN/802.15), cellular (e.g., 3G, 4G, or 5G including LTE/LTE-A/TD-LTE/TD-LTE, GSM, etc. variants thereof), IrDA families, etc. As used herein, Wi-Fi may include one or more of IEEE-Std. 802.11, variants of IEEE-Std. 802.11, standards related to IEEE-Std. 802.11 (e.g., 802.11 a/b/g/n/ac/ad/af/ah/ai/aj/aq/ax/ay), and/or other wireless standards.

As used herein, processor, microprocessor, and/or digital processor may include any type of digital processing device such as, without limitation, digital signal processors (“DSPs”), reduced instruction set computers (“RISC”), complex instruction set computers (“CISC”) processors, microprocessors, gate arrays (e.g., field programmable gate arrays (“FPGAs”)), programmable logic device (“PLDs”), reconfigurable computer fabrics (“RCFs”), array processors, secure microprocessors, and application-specific integrated circuits (“ASICs”). Such digital processors may be contained on a single unitary integrated circuit die or distributed across multiple components.

As used herein, computer program and/or software may include any sequence or human or machine cognizable steps which perform a function. Such computer program and/or software may be rendered in any programming language or environment including, for example, C/C++, C#, Fortran, COBOL, MATLAB™, PASCAL, GO, RUST, SCALA, Python, assembly language, markup languages (e.g., HTML, SGML, XML, VoXML), and the like, as well as object-oriented environments such as the Common Object Request Broker Architecture (“CORBA”), JAVA™ (including J2ME, Java Beans, etc.), Binary Runtime Environment (e.g., “BREW”), and the like.

As used herein, connection, link, and/or wireless link may include a causal link between any two or more entities (whether physical or logical/virtual), which enables information exchange between the entities.

As used herein, computer and/or computing device may include, but are not limited to, personal computers (“PCs”) and minicomputers, whether desktop, laptop, or otherwise, mainframe computers, workstations, servers, personal digital assistants (“PDAs”), handheld computers, embedded computers, programmable logic devices, personal communicators, tablet computers, mobile devices, portable navigation aids, J2ME equipped devices, cellular telephones, smart phones, personal integrated communication or entertainment devices, and/or any other device capable of executing a set of instructions and processing an incoming data signal.

Detailed descriptions of the various embodiments of the system and methods of the disclosure are now provided. While many examples discussed herein may refer to specific exemplary embodiments, it will be appreciated that the described systems and methods contained herein are applicable to any kind of robot. Myriad other embodiments or uses for the technology described herein would be readily envisaged by those having ordinary skill in the art, given the contents of the present disclosure.

Advantageously, the systems and methods of this disclosure at least: (i) adapt robotic speed limits to best suit environmental conditions; (ii) maintain safety considerations, and (iii) provide a light-weight method for rapidly addressing changes to a route or path. Other advantages are readily discernable by one having ordinary skill in the art given the contents of the present disclosure.

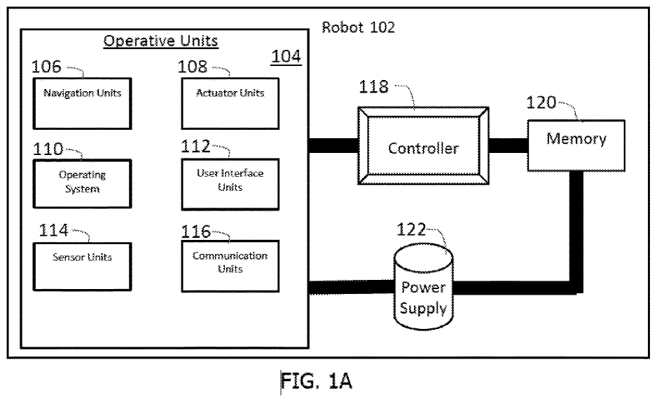

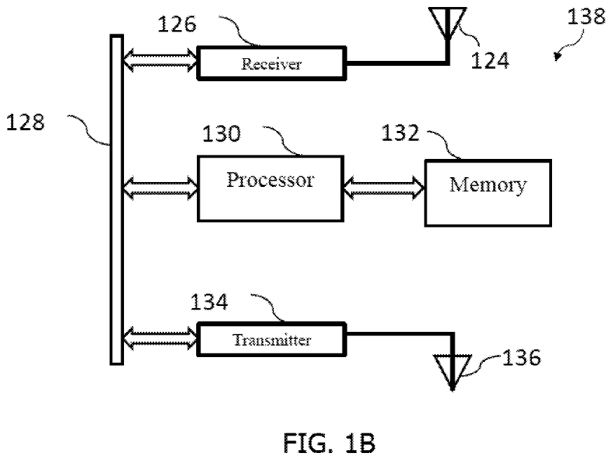

FIG. 1A is a functional block diagram of a robot 102 in accordance with some principles of this disclosure. As illustrated in FIG. 1A, robot 102 may include controller 118, memory 120, user interface unit 112, sensor units 114, navigation units 106, actuator unit 108, and communications unit 116, as well as other components and subcomponents (e.g., some of which may not be illustrated). Although a specific embodiment is illustrated in FIG. 1A, it is appreciated that the architecture may be varied in certain embodiments as would be readily apparent to one of ordinary skill given the contents of the present disclosure. As used herein, robot 102 may be representative at least in part of any robot described in this disclosure.

Controller 118 may control the various operations performed by robot 102. Controller 118 may include and/or comprise one or more processing devices (e.g., microprocessing devices) and other peripherals. As previously mentioned and used herein, processing device, microprocessing device, and/or digital processing device may include any type of digital processing device such as, without limitation, digital signal processing devices (“DSPs”), reduced instruction set computers (“RISC”), complex instruction set computers (“CISC”), microprocessing devices, gate arrays (e.g., field programmable gate arrays (“FPGAs”)), programmable logic device (“PLDs”), reconfigurable computer fabrics (“RCFs”), array processing devices, secure microprocessing devices and application-specific integrated circuits (“ASICs”). Peripherals may include hardware accelerators configured to perform a specific function using hardware elements such as, without limitation, encryption/description hardware, algebraic processing devices (e.g., tensor processing units, quadradic problem solvers, multipliers, etc.), data compressors, encoders, arithmetic logic units (“ALU”), and the like. Such digital processing devices may be contained on a single unitary integrated circuit die, or distributed across multiple components.

Controller 118 may be operatively and/or communicatively coupled to memory 120. Memory 120 may include any type of integrated circuit or other storage device configured to store digital data including, without limitation, read-only memory (“ROM”), random access memory (“RAM”), non-volatile random access memory (“NVRAM”), programmable read-only memory (“PROM”), electrically erasable programmable read-only memory (“EEPROM”), dynamic random-access memory (“DRAM”), Mobile DRAM, synchronous DRAM (“SDRAM”), double data rate SDRAM (“DDR/2 SDRAM”), extended data output (“EDO”) RAM, fast page mode RAM (“FPM”), reduced latency DRAM (“RLDRAM”), static RAM (“SRAM”), flash memory (e.g., NAND/NOR), memristor memory, pseudostatic RAM (“PSRAM”), etc. Memory 120 may provide computer-readable instructions and data to controller 118. For example, memory 120 may be a non-transitory, computer-readable storage apparatus and/or medium having a plurality of instructions stored thereon, the instructions being executable by a processing apparatus (e.g., controller 118) to operate robot 102. In some cases, the computer-readable instructions may be configured to, when executed by the processing apparatus, cause the processing apparatus to perform the various methods, features, and/or functionality described in this disclosure. Accordingly, controller 118 may perform logical and/or arithmetic operations based on program instructions stored within memory 120. In some cases, the instructions and/or data of memory 120 may be stored in a combination of hardware, some located locally within robot 102, and some located remote from robot 102 (e.g., in a cloud, server, network, etc.).

It should be readily apparent to one of ordinary skill in the art that a processing device may be internal to or on board robot 102 and/or may be external to robot 102 and be communicatively coupled to controller 118 of robot 102 utilizing communication units 116 wherein the external processing device may receive data from robot 102, process the data, and transmit computer-readable instructions back to controller 118. In at least one non-limiting exemplary embodiment, the processing device may be on a remote server (not shown).

In some exemplary embodiments, memory 120, shown in FIG. 1A, may store a library of sensor data. In some cases, the sensor data may be associated at least in part with objects and/or people. In exemplary embodiments, this library may include sensor data related to objects and/or people in different conditions, such as sensor data related to objects and/or people with different compositions (e.g., materials, reflective properties, molecular makeup, etc.), different lighting conditions, angles, sizes, distances, clarity (e.g., blurred, obstructed/occluded, partially off frame, etc.), colors, surroundings, and/or other conditions. The sensor data in the library may be taken by a sensor (e.g., a sensor of sensor units 114 or any other sensor) and/or generated automatically, such as with a computer program that is configured to generate/simulate (e.g., in a virtual world) library sensor data (e.g., which may generate/simulate these library data entirely digitally and/or beginning from actual sensor data) from different lighting conditions, angles, sizes, distances, clarity (e.g., blurred, obstructed/occluded, partially off frame, etc.), colors, surroundings, and/or other conditions. The number of images in the library may depend at least in part on one or more of the amount of available data, the variability of the surrounding environment in which robot 102 operates, the complexity of objects and/or people, the variability in appearance of objects, physical properties of robots, the characteristics of the sensors, and/or the amount of available storage space (e.g., in the library, memory 120, and/or local or remote storage). In exemplary embodiments, at least a portion of the library may be stored on a network (e.g., cloud, server, distributed network, etc.) and/or may not be stored completely within memory 120. As yet another exemplary embodiment, various robots (e.g., that are commonly associated, such as robots by a common manufacturer, user, network, etc.) may be networked so that data captured by individual robots are collectively shared with other robots. In such a fashion, these robots may be configured to learn and/or share sensor data in order to facilitate the ability to readily detect and/or identify errors and/or assist events.

Still referring to FIG. 1A, operative units 104 may be coupled to controller 118, or any other controller, to perform the various operations described in this disclosure. One, more, or none of the modules in operative units 104 may be included in some embodiments. Throughout this disclosure, reference may be to various controllers and/or processing devices. In some embodiments, a single controller (e.g., controller 118) may serve as the various controllers and/or processing devices described. In other embodiments different controllers and/or processing devices may be used, such as controllers and/or processing devices used particularly for one or more operative units 104. Controller 118 may send and/or receive signals, such as power signals, status signals, data signals, electrical signals, and/or any other desirable signals, including discrete and analog signals to operative units 104. Controller 118 may coordinate and/or manage operative units 104, and/or set timings (e.g., synchronously or asynchronously), turn off/on control power budgets, receive/send network instructions and/or updates, update firmware, send interrogatory signals, receive and/or send statuses, and/or perform any operations for running features of robot 102.

Returning to FIG. 1A, operative units 104 may include various units that perform functions for robot 102. For example, operative units 104 includes at least navigation units 106, actuator units 108, user interface units 112, sensor units 114, and communication units 116. Operative units 104 may also comprise other units such as specifically configured task units (not shown) that provide the various functionality of robot 102. In exemplary embodiments, operative units 104 may be instantiated in software, hardware, or both software and hardware. For example, in some cases, units of operative units 104 may comprise computer implemented instructions executed by a controller. In exemplary embodiments, units of operative unit 104 may comprise hardcoded logic (e.g., ASICS). In exemplary embodiments, units of operative units 104 may comprise both computer-implemented instructions executed by a controller and hardcoded logic. Where operative units 104 are implemented in part in software, operative units 104 may include units/modules of code configured to provide one or more functionalities.

In exemplary embodiments, navigation units 106 may include systems and methods that may computationally construct and update a map of an environment, localize robot 102 (e.g., find the position) in a map, and navigate robot 102 to/from destinations. The mapping may be performed by imposing data obtained in part by sensor units 114 into a computer-readable map representative at least in part of the environment. In exemplary embodiments, a map of an environment may be uploaded to robot 102 through user interface units 112, uploaded wirelessly or through wired connection, or taught to robot 102 by a user.

In exemplary embodiments, navigation units 106 may include components and/or software configured to provide directional instructions for robot 102 to navigate. Navigation units 106 may process maps, routes, and localization information generated by mapping and localization units, data from sensor units 114, and/or other operative units 104.

Still referring to FIG. 1A, actuator units 108 may include actuators such as electric motors, gas motors, driven magnet systems, solenoid/ratchet systems, piezoelectric systems (e.g., inchworm motors), magneto strictive elements, gesticulation, and/or any way of driving an actuator known in the art. By way of illustration, such actuators may actuate the wheels for robot 102 to navigate a route; navigate around obstacles; rotate cameras and sensors. According to exemplary embodiments, actuator unit 108 may include systems that allow movement of robot 102, such as motorize propulsion. For example, motorized propulsion may move robot 102 in a forward or backward direction, and/or be used at least in part in turning robot 102 (e.g., left, right, and/or any other direction). By way of illustration, actuator unit 108 may control if robot 102 is moving or is stopped and/or allow robot 102 to navigate from one location to another location.

Actuator unit 108 may also include any system used for actuating and, in some cases actuating task units to perform tasks. For example, actuator unit 108 may include driven magnet systems, motors/engines (e.g., electric motors, combustion engines, steam engines, and/or any type of motor/engine known in the art), solenoid/ratchet system, piezoelectric system (e.g., an inchworm motor), magnetostrictive elements, gesticulation, and/or any actuator known in the art.

According to exemplary embodiments, sensor units 114 may comprise systems and/or methods that may detect characteristics within and/or around robot 102. Sensor units 114 may comprise a plurality and/or a combination of sensors. Sensor units 114 may include sensors that are internal to robot 102 or external, and/or have components that are partially internal and/or partially external. In some cases, sensor units 114 may include one or more exteroceptive sensors, such as sonars, light detection and ranging (“LiDAR”) sensors, radars, lasers, cameras (including video cameras (e.g., red-blue-green (“RBG”) cameras, infrared cameras, three-dimensional (“3D”) cameras, thermal cameras, etc.), time of flight (“ToF”) cameras, structured light cameras, etc.), antennas, motion detectors, microphones, and/or any other sensor known in the art. According to some exemplary embodiments, sensor units 114 may collect raw measurements (e.g., currents, voltages, resistances, gate logic, etc.) and/or transformed measurements (e.g., distances, angles, detected points in obstacles, etc.). In some cases, measurements may be aggregated and/or summarized. Sensor units 114 may generate data based at least in part on distance or height measurements. Such data may be stored in data structures, such as matrices, arrays, queues, lists, arrays, stacks, bags, etc.

According to exemplary embodiments, sensor units 114 may include sensors that may measure internal characteristics of robot 102. For example, sensor units 114 may measure temperature, power levels, statuses, and/or any characteristic of robot 102. In some cases, sensor units 114 may be configured to determine the odometry of robot 102. For example, sensor units 114 may include proprioceptive sensors, which may comprise sensors such as accelerometers, inertial measurement units (“IMU”), odometers, gyroscopes, speedometers, cameras (e.g. using visual odometry), clock/timer, and the like. Odometry may facilitate autonomous navigation and/or autonomous actions of robot 102. This odometry may include robot 102's position (e.g., where position may include robot's location, displacement and/or orientation, and may sometimes be interchangeable with the term pose as used herein) relative to the initial location. Such data may be stored in data structures, such as matrices, arrays, queues, lists, arrays, stacks, bags, etc. According to exemplary embodiments, the data structure of the sensor data may be called an image.

According to exemplary embodiments, sensor units 114 may be in part external to the robot 102 and coupled to communications units 116. For example, a security camera within an environment of a robot 102 may provide a controller 118 of the robot 102 with a video feed via wired or wireless communication channel(s). In some instances, sensor units 114 may include sensors configured to detect a presence of an object at a location such as, for example without limitation, a pressure or motion sensor may be disposed at a shopping cart storage location of a grocery store, wherein the controller 118 of the robot 102 may utilize data from the pressure or motion sensor to determine if the robot 102 should retrieve more shopping carts for customers.

According to exemplary embodiments, user interface units 112 may be configured to enable a user to interact with robot 102. For example, user interface units 112 may include touch panels, buttons, keypads/keyboards, ports (e.g., universal serial bus (“USB”), digital visual interface (“DVI”), Display Port, E-Sata, Firewire, PS/2, Serial, VGA, SCSI, audioport, high-definition multimedia interface (“HDMI”), personal computer memory card international association (“PCMCIA”) ports, memory card ports (e.g., secure digital (“SD”) and miniSD), and/or ports for computer-readable medium), mice, rollerballs, consoles, vibrators, audio transducers, and/or any interface for a user to input and/or receive data and/or commands, whether coupled wirelessly or through wires. Users may interact through voice commands or gestures. User interface units 218 may include a display, such as, without limitation, liquid crystal display (“LCDs”), light-emitting diode (“LED”) displays, LED LCD displays, in-plane-switching (“IPS”) displays, cathode ray tubes, plasma displays, high definition (“HD”) panels, 4K displays, retina displays, organic LED displays, touchscreens, surfaces, canvases, and/or any displays, televisions, monitors, panels, and/or devices known in the art for visual presentation. According to exemplary embodiments user interface units 112 may be positioned on the body of robot 102. According to exemplary embodiments, user interface units 112 may be positioned away from the body of robot 102 but may be communicatively coupled to robot 102 (e.g., via communication units including transmitters, receivers, and/or transceivers) directly or indirectly (e.g., through a network, server, and/or a cloud). According to exemplary embodiments, user interface units 112 may include one or more projections of images on a surface (e.g., the floor) proximally located to the robot, e.g., to provide information to the occupant or to people around the robot. The information could be the direction of future movement of the robot, such as an indication of moving forward, left, right, back, at an angle, and/or any other direction. In some cases, such information may utilize arrows, colors, symbols, etc.

According to exemplary embodiments, communications unit 116 may include one or more receivers, transmitters, and/or transceivers. Communications unit 116 may be configured to send/receive a transmission protocol, such as BLUETOOTH®, ZIGBEE®, Wi-Fi, induction wireless data transmission, radio frequencies, radio transmission, radio-frequency identification (“RFID”), near-field communication (“NFC”), infrared, network interfaces, cellular technologies such as 3G (3.5G, 3.75G, 3GPP/3GPP2/HSPA+), 4G (4GPP/4GPP2/LTE/LTE-TDD/LTE-FDD), 5G (5GPP/5GPP2 ), or 5G LTE (long-term evolution, and variants thereof including LTE-A, LTE-U, LTE-A Pro, etc.), high-speed downlink packet access (“HSDPA”), high-speed uplink packet access (“HSUPA”), time division multiple access (“TDMA”), code division multiple access (“CDMA”) (e.g., IS-95A, wideband code division multiple access (“WCDMA”), etc.), frequency hopping spread spectrum (“FHSS”), direct sequence spread spectrum (“DSSS”), global system for mobile communication (“GSM”), Personal Area Network (“PAN”) (e.g., PAN/802.15), worldwide interoperability for microwave access (“WiMAX”), 802.20, long term evolution (“LTE”) (e.g., LTE/LTE-A), time division LTE (“TD-LTE”), global system for mobile communication (“GSM”), narrowband/frequency-division multiple access (“FDMA”), orthogonal frequency-division multiplexing (“OFDM”), analog cellular, cellular digital packet data (“CDPD”), satellite systems, millimeter wave or microwave systems, acoustic, infrared (e.g., infrared data association (“IrDA”)), and/or any other form of wireless data transmission.

Communications unit 116 may also be configured to send/receive signals utilizing a transmission protocol over wired connections, such as any cable that has a signal line and ground. For example, such cables may include Ethernet cables, coaxial cables, Universal Serial Bus (“USB”), FireWire, and/or any connection known in the art. Such protocols may be used by communications unit 116 to communicate to external systems, such as computers, smart phones, tablets, data capture systems, mobile telecommunications networks, clouds, servers, or the like. Communications unit 116 may be configured to send and receive signals comprising of numbers, letters, alphanumeric characters, and/or symbols. In some cases, signals may be encrypted, using algorithms such as 128-bit or 256-bit keys and/or other encryption algorithms complying with standards such as the Advanced Encryption Standard (“AES”), RSA, Data Encryption Standard (“DES”), Triple DES, and the like. Communications unit 116 may be configured to send and receive statuses, commands, and other data/information. For example, communications unit 116 may communicate with a user operator to allow the user to control robot 102. Communications unit 116 may communicate with a server/network (e.g., a network) in order to allow robot 102 to send data, statuses, commands, and other communications to the server. The server may also be communicatively coupled to computer(s) and/or device(s) that may be used to monitor and/or control robot 102 remotely. Communications unit 116 may also receive updates (e.g., firmware or data updates), data, statuses, commands, and other communications from a server for robot 102.

In exemplary embodiments, operating system 110 may be configured to manage memory 120, controller 118, power supply 122, modules in operative units 104, and/or any software, hardware, and/or features of robot 102. For example, and without limitation, operating system 110 may include device drivers to manage hardware recourses for robot 102.

In exemplary embodiments, power supply 122 may include one or more batteries, including, without limitation, lithium, lithium ion, nickel-cadmium, nickel-metal hydride, nickel-hydrogen, carbon-zinc, silver-oxide, zinc-carbon, zinc-air, mercury oxide, alkaline, or any other type of battery known in the art. Certain batteries may be rechargeable, such as wirelessly (e.g., by resonant circuit and/or a resonant tank circuit) and/or plugging into an external power source. Power supply 122 may also be any supplier of energy, including wall sockets and electronic devices that convert solar, wind, water, nuclear, hydrogen, gasoline, natural gas, fossil fuels, mechanical energy, steam, and/or any power source into electricity.

One or more of the units described with respect to FIG. 1A (including memory 120, controller 118, sensor units 114, user interface unit 112, actuator unit 108, communications unit 116, mapping and localization unit 126, and/or other units) may be integrated onto robot 102, such as in an integrated system. However, according to some exemplary embodiments, one or more of these units may be part of an attachable module. This module may be attached to an existing apparatus to automate so that it behaves as a robot. Accordingly, the features described in this disclosure with reference to robot 102 may be instantiated in a module that may be attached to an existing apparatus and/or integrated onto robot 102 in an integrated system. Moreover, in some cases, a person having ordinary skill in the art would appreciate from the contents of this disclosure that at least a portion of the features described in this disclosure may also be run remotely, such as in a cloud, network, and/or server.

As used herein, a robot 102, a controller 118, or any other controller, processing device, or robot performing a task, operation or transformation illustrated in the figures below comprises a controller executing computer readable instructions stored on a non-transitory computer readable storage apparatus, such as memory 120, as would be appreciated by one skilled in the art.

Next referring to FIG. 1B, the architecture of a processor or processing device 138 is illustrated according to an exemplary embodiment. As illustrated in FIG. 1B, the processing device 138 includes a data bus 128, a receiver 126, a transmitter 134, at least one processor 130, and a memory 132. The receiver 126, the processor 130 and the transmitter 134 all communicate with each other via the data bus 128. The processor 130 is configurable to access the memory 132 which stores computer code or computer readable instructions in order for the processor 130 to execute the specialized algorithms. As illustrated in FIG. 1B, memory 132 may comprise some, none, different, or all of the features of memory 120 previously illustrated in FIG. 1A. The algorithms executed by the processor 130 are discussed in further detail below. The receiver 126 as shown in FIG. 1B is configurable to receive input signals 124. The input signals 124 may comprise signals from a plurality of operative units 104 illustrated in FIG. 1A including, but not limited to, sensor data from sensor units 114, user inputs, motor feedback, external communication signals (e.g., from a remote server), and/or any other signal from an operative unit 104 requiring further processing. The receiver 126 communicates these received signals to the processor 130 via the data bus 128. As one skilled in the art would appreciate, the data bus 128 is the means of communication between the different components—receiver, processor, and transmitter—in the processing device. The processor 130 executes the algorithms, as discussed below, by accessing specialized computer-readable instructions from the memory 132. Further detailed description as to the processor 130 executing the specialized algorithms in receiving, processing and transmitting of these signals is discussed above with respect to FIG. 1A. The memory 132 is a storage medium for storing computer code or instructions. The storage medium may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage medium may include volatile, nonvolatile, dynamic, static, read/write, read-only, random-access, sequential-access, location-addressable, file-addressable, and/or content-addressable devices. The processor 130 may communicate output signals to transmitter 134 via data bus 128 as illustrated. The transmitter 134 may be configurable to further communicate the output signals to a plurality of operative units 104 illustrated by signal output 136.

One of ordinary skill in the art would appreciate that the architecture illustrated in FIG. 1B may illustrate an external server architecture configurable to effectuate the control of a robotic apparatus from a remote location. That is, the server may also include a data bus, a receiver, a transmitter, a processor, and a memory that stores specialized computer readable instructions thereon.

One of ordinary skill in the art would appreciate that a controller 118 of a robot 102 may include one or more processing devices 138 and may further include other peripheral devices used for processing information, such as ASICS, DPS, proportional-integral-derivative (“PID”) controllers, hardware accelerators (e.g., encryption/decryption hardware), and/or other peripherals (e.g., analog to digital converters) described above in FIG. 1A. The other peripheral devices when instantiated in hardware are commonly used within the art to accelerate specific tasks (e.g., multiplication, encryption, etc.) which may alternatively be performed using the system architecture of FIG. 1B. In some instances, peripheral devices are used as a means for intercommunication between the controller 118 and operative units 104 (e.g., digital to analog converters and/or amplifiers for producing actuator signals). Accordingly, as used herein, the controller 118 executing computer readable instructions to perform a function may include one or more processing devices 138 thereof executing computer readable instructions and, in some instances, the use of any hardware peripherals known within the art. Controller 118 may be illustrative of various processing devices 138 and peripherals integrated into a single circuit die or distributed to various locations of the robot 102 which receive, process, and output information to/from operative units 104 of the robot 102 to effectuate control of the robot 102 in accordance with instructions stored in a memory 120, 132. For example, controller 118 may include a plurality of processing devices 138 for performing high level tasks (e.g., planning a route to avoid obstacles) and processing devices 138 for performing low-level tasks (e.g., producing actuator signals in accordance with the route).

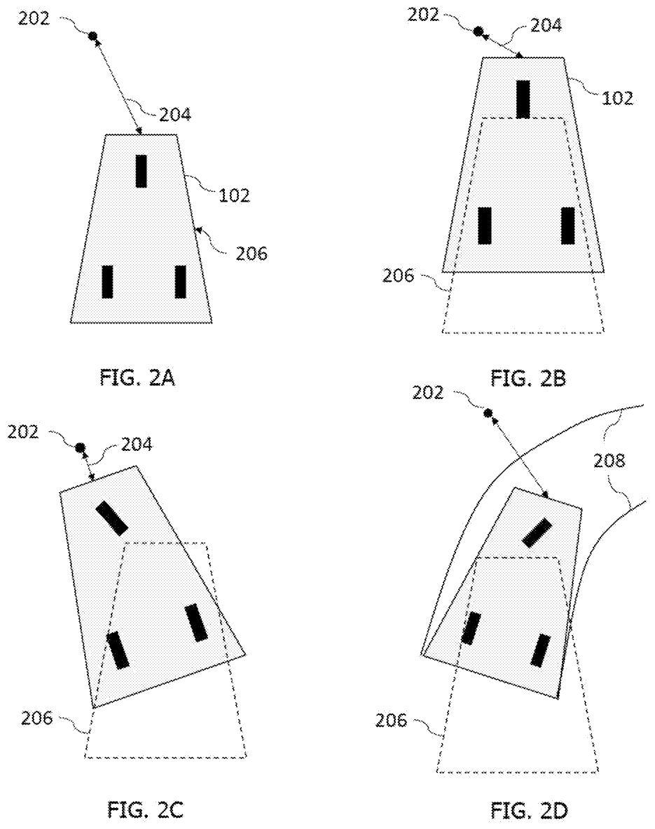

FIGS. 2A-D illustrate a robot 102 executing various maneuvers at distances relative to objects at various speeds which are safe from collisions, according to an exemplary embodiment. The following disclosure discusses systems and methods for configuring a dynamic speed limit for robots 102 to travel at, wherein it is preferred to travel at the maximum speed limit to minimize task execution time. Stated another way, it is ideal for the robot 102 to navigate as quickly as it safely is able to (i.e., without colliding with objects), wherein the speed limits are dynamically configured to account for safety. Beginning at FIG. 2A, the robot 102 is in a starting position 206. Proximate to the robot 102 is a point 202 which represents an object, sudden drop, or other hazard or area in the environment the robot 102 should avoid. In this exemplary embodiment, the point 202 represents the closest hazard to the robot 102 that should be avoided, wherein other points that localize objects are omitted for clarity.

The robot 102 shown comprises of a tricycle wheel configuration, which causes the robot 102 to turn at a non-zero turn radius. Other drive configurations are considered and are within the scope of this disclosure, such as four-wheel drive robots 102. Differential drive robots 102 with a zero-turn radius may be handled in a similar manner, as discussed further below.

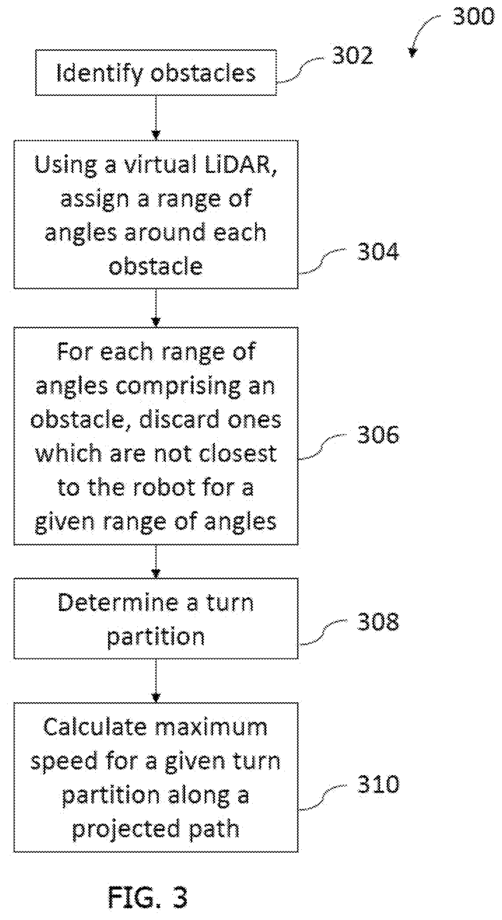

The present disclosure relates to configuring dynamic speed limits for robot 102, wherein the speed limit as used herein refers to the maximum operational speed of the robot 102, assuming no other circumstances which prevent operation such as software and/or mechanical failures or emergency stops. If the robot 102 is traveling beyond the maximum speed, the controller 118 may engage brakes to slow the robot 102 to the maximum safe speed or stop the robot 102 altogether. The dynamic speed limits herein will be configured in accordance with the environmental conditions present, a stopping distance of the robot 102, and a desired movement of the robot 102. The speed limits, importantly, will ensure the robot 102 has sufficient stopping distance to fully stop before colliding with an object point 202. From the starting position in FIG. 2A, the robot 102 has a distance 204 to the point 202. Based on this distance and considering the maximum stopping distance of the robot 102, a maximum safe speed limit may be calculated in accordance with method 300 shown in FIG. 3.

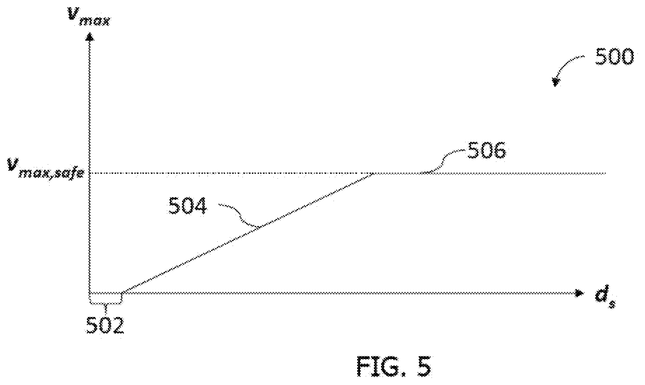

In FIG. 2B the robot 102 drives straight and forward from its starting position 206, shown by dashed outline, to the illustrated position of robot 102. As a result, the robot 102 is closer to the point 202 and should therefore slow down such that the robot 102 can stop completely before contacting the point 202. In other words, due to the reduction in available stopping distance, the robot 102 should slow down to in turn reduce the distance it needs to stop prior to the object point 202 in order to avoid coming in contact with the point 202. From the current position of robot 102 in FIG. 2B, and continuing forward, the maximum speed limit of the robot 102 is substantially reduced from the speed limit in FIG. 2A, as represented by the varying length of ray 204 between the robot 102 and the point 202. The speed limit reduction may follow a continuous speed limit function (e.g., shown in FIG. 5) that is a function of (i) the distance to the nearest point 202, and (ii) the stopping distance of the robot 102 at the maximum speed limit along a given direction (not the current speed of the robot, which may vary due to dynamic objects or turns). While continuing forward, the point 202 would, eventually, intersect with the robot 102. Accordingly, distance between the robot 102 and the point 202 is used to calculate the maximum speed limit of the robot 102 to ensure the robot 102 does not collide with the point 202 and can stop beforehand. As the robot 102 further approaches the point 202, the speed limit would eventually decrease to zero indicating there is no viable movement permitted at least in this direction and naturally stopping the robot 102 prior to collision.

FIG. 2C illustrates the robot 102 executing a left-hand turn, which causes the robot 102 to approach the point 202 more directly as compared to FIG. 2B. Accordingly, the speed limit gradually decreases as the robot 102 executes the turn until the point 202 is directly adjacent to the robot 102. In other words, as the available distance to stop shown by ray 204 decreases to zero, so too does the speed limit of robot 102, thereby stopping the robot 102 before colliding with the point 202. In some embodiments, the maximum stopping distance can be overestimated or include a constant added onto the stopping distance of the robot 102 (e.g., by adding 3 cm to the stopping distance; see FIG. 5 section 502) to ensure a proper safety margin during stopping that accounts for variabilities in the environment and in the sensor data, e.g., due to sensor noise. Since the point 202 is within the path of the robot 102 in both FIG. 2B-C, the maximum speed limits would both gradually decrease as the robot 102 maneuvers, thereby naturally slowing or stopping the robot 102 as necessary.

Lastly, in FIG. 2D, the robot 102 is turning rightward from the starting position 206. As shown by path outlines 208, representing the area encompassed by the robot 102 during the rightward turn, there is no intersection with the point 202 and the robot 102 as the robot 102 travels away from the point 202. Accordingly, since no collision is present along the traveled path, the maximum speed limit may be kept at a maximum value, assuming no other objects or safety restrictions are present. In other words, since the path outlines 208 do not encompass the point 202, there is no risk of collision and therefore it is not considered in the speed limit calculation for the rightward turn. The path outlines 208 may be calculated via either motion primitives, whereby the robot 102 pre-calculates the maneuver and area encompassed (or selects from pre-computed values) or projecting/convolving a footprint (i.e., digital representation of the area occupied by the robot) of itself along the desired path, wherein the pixels of the map overlapped by the projected footprint correspond to pixels within the path outlines 208. At any time during the turn, if the robot 102 engages its brakes while traveling at the speed limit, it will never touch the point 202, as a collision with point 202 would also require a change in turning angle of robot 102. Accordingly, the point 202, and specifically ray 204 between point 202 and robot 102, does not define the available stopping distance as there is no risk of collision while executing this right-hand turn.

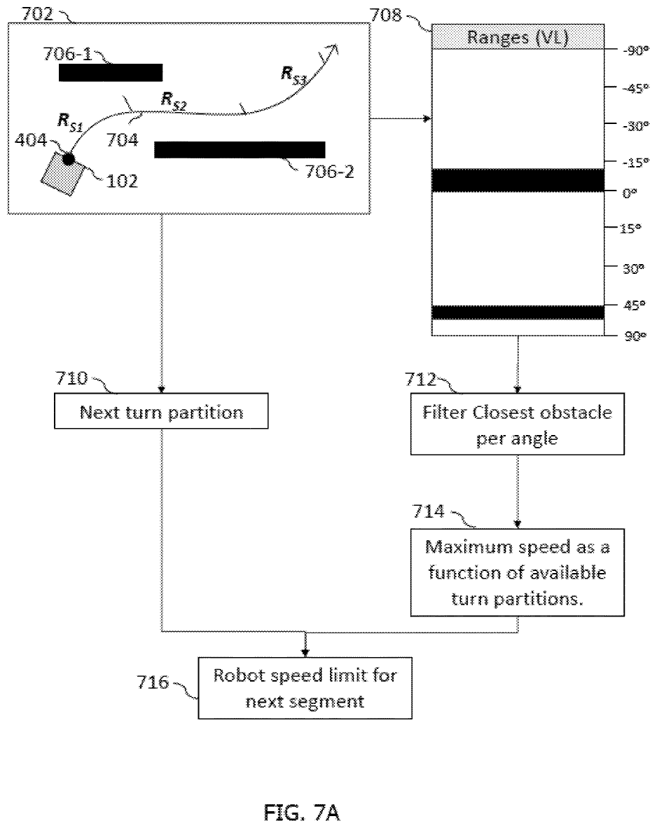

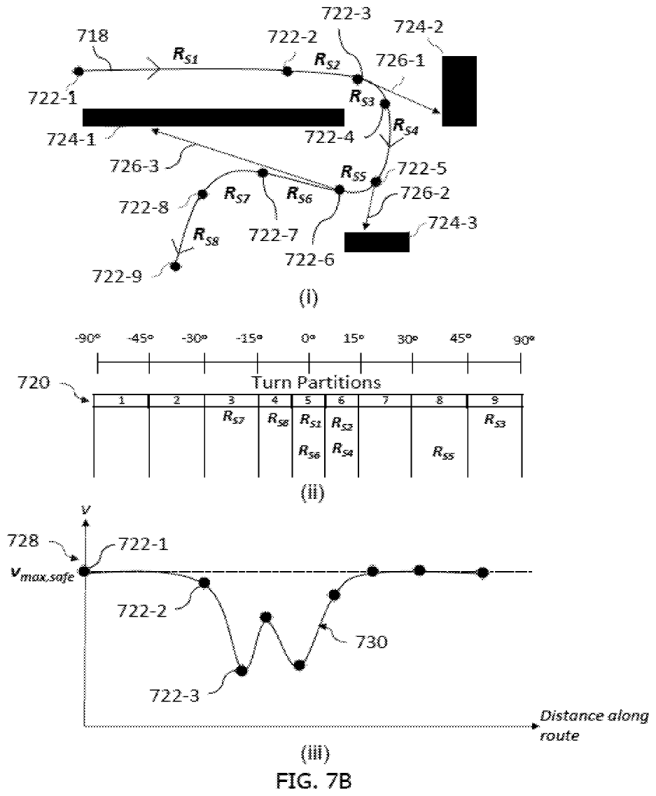

As used herein, the term “turn partition” refers to a discrete range of turning angles for a robot 102. A more detailed and visual explanation is provided in FIG. 7B. In some embodiments, the robot 102 may include a range of possible turning angles, e.g., from −90° to +90°, or larger. This range of possible turning angles is discretized into a plurality of partitions, each denoted as a ‘turn partition’ herein. For example, the straight and forward movement in FIG. 2B may be a first turn partition corresponding to motions that are within −5° to +5° from a straightforward heading of 0°. And, the movement in FIG. 2C may correspond to another turn partition corresponding to turns ranging from −30° to −20°, and the movement in FIG. 2D may correspond to a third turn partition for turns ranging from +20° to +30°. It is appreciated that partitioning the turn partitions by increments of 10° is non-limiting and is for illustrative purposes only. A person of ordinary skill in the art may configure the partitions to have larger or smaller turning ranges than discussed herein. Turn partitions may be implemented via, for example, a look up table which receives the steering angle of the robot 102 to follow a given route as input and, based on the angle falling within the range of a turn partition in the look up table, identify the corresponding turn partition.

FIG. 3 is a process flow diagram illustrating a method 300 for a controller 118 of a robot 102 to configure a speed limit for the robot 102, according to an exemplary embodiment. Steps of method 300 are effectuated via controller 118 executing instructions from a non-transitory memory 120.

Method 300 begins with the controller 118 identifying obstacles in block 302. Identifying obstacles may include, for instance, receiving ranging measurements from LiDAR sensors, processing the ranging measurements into pixels on a map which represent obstacles, or otherwise sensing and localizing the obstacles. The obstacles may include objects, people/animals, cliffs, and/or unnavigable floor space and may be detected by one or many sensor units 112 or provided by user input (e.g., keep out regions where a user prevents a robot 102 from navigating in regardless of physical objects).

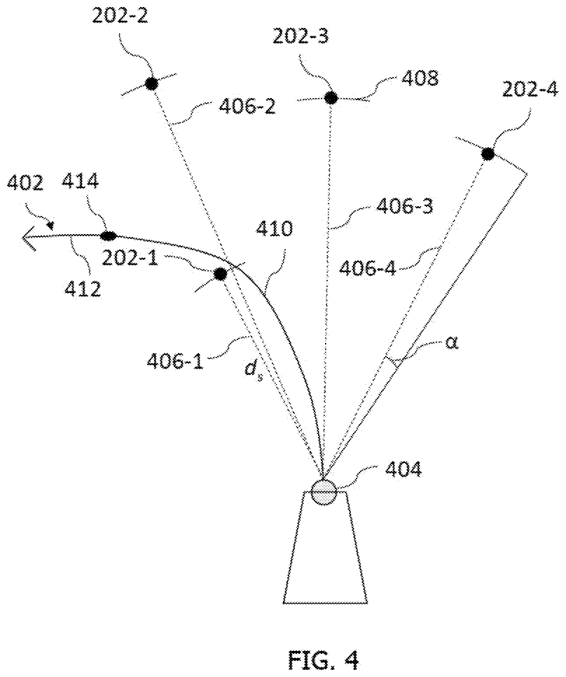

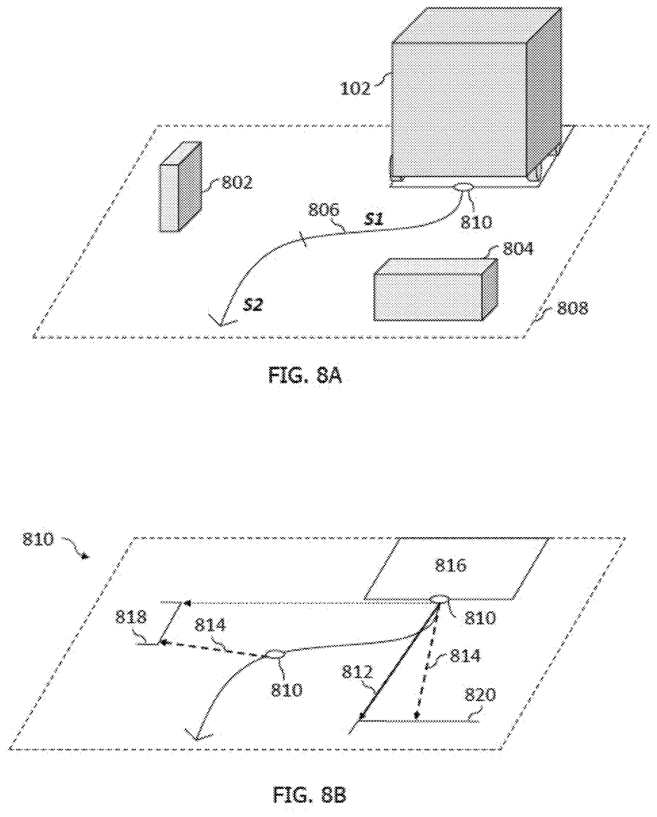

Next, in block 304, the controller 118 simulates a virtual LiDAR to assign a range of angles around each obstacle. A virtual LiDAR as used herein does not have to correspond to a physical LiDAR sensor of the robot 102, although in some instances a physical LiDAR sensor may coincide with the position of the virtual LiDAR. Rather, a virtual LiDAR comprises a designated point on the robot 102 which defines the distance or range of distances from the robot to the obstacles in a similar manner as a physical LiDAR sensor scans the environment for distance measurements. Further discussion on physical LiDAR and virtual LiDAR is presented bellow with respect to FIG. 4. The virtual LiDAR discussed herein may be positioned at (i) the geometric center of the robot 102 (e.g., for holonomic robots 102), or (ii) the front-center of the robot (e.g., as shown in FIG. 4), as seen from a top-down perspective. During the mapping process, objects that are detected by physical sensors, e.g., a physical LiDAR sensor, are projected onto a flat plane of the map which is parallel to the floor, wherein the virtual LiDAR is placed at the same height as the map plane. Next, the range and angle for an obstacle identified in block 302 with respect to the designated origin point of the virtual LiDAR are calculated. In effect, the virtual LiDAR acts as a single origin from which ranges and angles to object points are measured, based on data from one or more physical sensor units 114, (e.g., as if a single LiDAR sensor measured all of the object points form the virtual LiDAR position). The controller 118 additionally assigns a range of angles to each obstacle point, as shown in FIG. 4 (see, e.g., arc 408). The range of angles may comprise a predetermined value, e.g., 5° about the origin of the virtual LiDAR in both the clockwise and the counterclockwise directions. A visual depiction of the configuration of a virtual LiDAR is provided in FIG. 8A-B.

Block 306 includes the controller 118 discarding angular ranges that correspond to obstacles which are not closest to the robot 102 for a given direction. In other words, the robot 102 in block 304 may have identified a plurality of obstacles and assigned angular ranges thereto. Some of those obstacles may be behind other obstacles, wherein the farther away obstacles are considered when calculating a safe speed limit, as the nearest obstacle determines the safe stopping distance. Accordingly, for any angle about the virtual LiDAR origin point, if multiple obstacle points are along the given angle, only the closest one to the robot 102 along its traveled path is considered herein and the others are discarded.

Referring briefly to FIG. 4, a plurality of object points including points 202-1 and 202-2 are detected. These points 202-1 and 202-2 are assigned a range/distance 406-1, 406-2 and angle with respect to a virtual LiDAR origin 404. The range of angles assigned to each object point 202-1, 202-2 is shown via arcs 408 corresponding to each. In accordance with block 306, point 202-2 lies behind the arc 408 of the point 202-1, as shown by ray 406-2 passing through the arc 408 associated with point 202-1. Accordingly, point 202-2 is discarded in block 306. Range 406-1 corresponds to the range of the closest obstacle point 202-1. Additionally, points which are outside of the robot 102 motion shown by path 402 such as 202-4 are ignored for the speed limit calculations.

Returning to FIG. 3, block 308 includes the controller 118 determining a turn partition for the robot 102 to follow. A turn partition may refer to an individual motion primitive or a discrete motion (e.g., discretized as a function of time or distance traveled) executed by the robot 102.

For embodiments which utilize motion primitives, each motion primitive comprises a pre-calculated maneuver. For example, a first motion primitive may include a straight or forward movement, another motion primitive may include a slight 5° left turn, another may include a 20° left turn, and so forth, for every possible motion for the robot 102. Since motion primitives are precalculated and discretized sets of motions to be executed in a sequence to follow a route, each motion primitive may be assigned to or correspond with a turn partition automatically precomputed. In some embodiments, each turn partition may correspond to one or more motion primitives. In some instances, a route 402 may comprise of a plurality of different sequentially executed motion primitives which may be defined within the same or different turn partitions. Each discrete segment of a route or maneuver to be executed by the robot corresponds to a turn partition. For instance, a first turn partition may encompass a robot 102 turning zero to 10° to the left, a second partition may correspond to the robot 102 turning 11° to 20° to the left, and so forth as well as vice versa for rightward turns, wherein each turn partition may correspond to one or multiple motion primitives.

For embodiments that do not utilize motion primitive navigation, it may be required that the range of possible motions the robot 102 may execute be discretized because the range of possible motions is now represented as a continuous function rather than a discrete set of primitives. One method of discretization includes a discretization over distance traveled, where each segment of the continuous route is only evaluated for speed limits when the segment is over N meter in length. A smaller value of N requires more iterations of method 300 but provides a more accurate speed limit in real time, whereas a larger value of N requires fewer iterations while maintaining a calculated speed limit for longer. Each discrete segment of a route or maneuver to be executed by the robot corresponds to a turn partition. Another exemplary method of discretizing turn partitions may comprise discretizing the range of steering angles of a steering wheel, steering column, or steered wheel(s) into angular ranges, such as (0°, 10°] as a first partition, (10°, 20°] as the next partition, and so forth.

Block 308 includes, in part, the controller 118 determining which turn partition corresponds to the discrete segment of route to execute that would cause the robot 102 to follow the desired path or perform the desired maneuver. In addition to determining this turn partition, the controller 118 may also evaluate other maneuvers which may correspond to other turn partitions which don't generate collisions in method 300 as well contemporaneously. Advantageously, contemporaneously evaluating all turn partitions enables the controller 118 to rapidly adjust the speed limit in the scenario where the robot 102 needs to quickly deviate from the original path, e.g., to avoid an unforeseen moving object. Unforeseen objects correspond to objects which are not presently localized onto the map but may suddenly appear in sensor readings, such as fast moving objects moving into the view of the sensor.

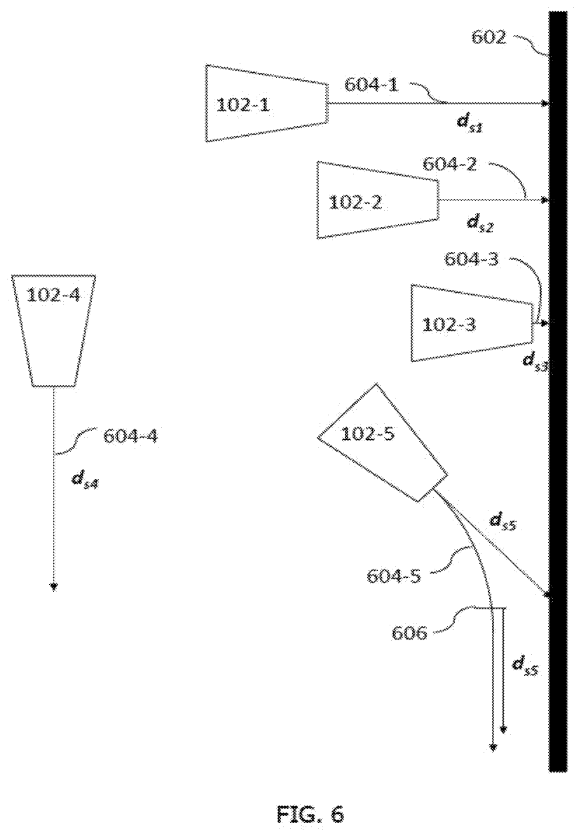

Lastly, in block 310, the controller 118 utilizes the turn partition and distance to the nearest objects to calculate its maximum speed. The turn partition is utilized to remove obstacles which are not along the robot 102 path from consideration in the speed limit calculation. The distance to obstacles is utilized to determine a lowest distance between the virtual LiDAR origin and the obstacles along the selected turn partition. When determining the speed limit, only the obstacle closest to the virtual LiDAR origin and along the traveled path of the robot 102 are considered. The speed limit may be calculated as a function of the stopping distance of the robot 102, which itself varies as a function of robot velocity as further discussed with respect to FIG. 6. Accordingly, the speed limit of the robot 102 is calculated via a feedback loop, the feedback loop taking the nearest relevant object distance as input (blocks 302-308) and using the current robot velocity (i.e., feedback) to update its speed limit for the next iteration/update. In some embodiments, a constant buffer can be added to the stopping distance to elongate the stopping distance to account for any sensor noise or imperfect localization, shown in FIG. 5 for example. Further, the robot 102's actual speed may be limited by other considerations, such as safety requirements from external regulatory agencies as discussed with reference to FIG. 5 as well.

Controller 118 may further perform the same speed limit calculations for other maneuvers which fall in different turn partitions which could be executed from the current position without collision. Calculating these speed limits contemporaneously enables the controller 118 to readily determine new speed limits if the path is changed. Similarly, the controller 118 may perform method 300 for a plurality of route segments ahead of its current position on the route or before navigating the route.

It is appreciated that the maximum stopping distance as a function of speed of the robot 102 may vary depending on the mass and drive configuration of the robot 102. It is suggested to empirically test and measure the actual stopping distance for any robotic device on various floor surface types, wherein the stopping distance as a function of the robot velocity is also empirically tested and defined. For robots which cannot detect the floor type they are navigating on, it is preferred to utilize the longest stopping distance measured on any of the floor types as a safety precaution.

FIG. 4 depicts a robot 102 from a top-down view encountering a plurality of objects and calculating its maximum speed limit for a given segment 410 of a traveled route 402, according to an exemplary embodiment. The robot 102 is configured to follow route 402 as quickly as possible while avoiding objects. The route 402 as illustrated comprises a first section 410 containing a left-hand turn of constant turn radius, followed by a straight section 412 having no curvature. These two sections 410 and 412, separated by point 414, each correspond to a different turn partition. The robot 102 may acquire various sensor unit 114 data and generate a map of its surroundings, which may include the four points 202 (202-1, 202-2, 202-3, 202-4), as well as others, omitted from FIG. 4 for clarity of illustration. The singular points 202 shown in FIG. 4 may comprise one or multiple measurements from sensor units 114, e.g., range measurements from a LiDAR sensor.

In this embodiment, the virtual LiDAR 404 is placed at the front of the robot 102 and is represented by its origin point at the height of the mapping plane, which is typically the floor or z=0 on a traditional cartesian coordinate grid. Other embodiments may place the virtual LiDAR 404 elsewhere, such as the center of the robot 102 or the left, right, or rear outer edges of the robot 102. The virtual LiDAR 404 does not need to correspond to a physical sensor or device on the robot 102. Rather, the virtual LiDAR acts as a simulated sensor calculating ranges as if a physical LiDAR sensor were placed at the location, the simulation being based on an aggregate of data from various physical sensors translated to a reference frame with the position of the virtual LiDAR as the origin. The LiDAR origin point 404 defines a plurality of rays 406 (e.g., 406-1, 406-2, 406-3, 406-4) that extend from the origin 404 to each object point 202 (202-1, 202-2, 202-3, 202-4) respectively. Each object point 202 is further assigned an angular range shown by arcs 408 as per step 306 in FIG. 3, wherein the arcs are portions of a circle centered about the origin 404 of the virtual LiDAR. Each arc 408 includes an angular extension of each point 202 by an angular distance α centered about the origin 404, as shown with respect to ray 406-4, for example to account for noise and/or imperfect localization. Since the arcs 408 are angularly defined, each point on the arcs 408 is of equal distance to the origin 404 of the virtual LiDAR as the corresponding point 202. The arcs 408 enable the controller 118 to determine a speed limit of the robot 102 using a conservative estimate, as the points 202 (which are dimensionless points in space) may not lie exactly along the route 402 but are sufficiently close to pose a risk.

The arcs 408 further enable the controller 118 to account for noisy localization of points 202 and filter other points 202 from consideration, thereby improving the cycle time of the method. The cycle time refers to the time needed for a robot 102 to calculate its trajectory and maximum speed for each segment or turn partition of the route 402. For example, the value of α may be proportional to the noise level or resolution of the sensors of the robot 102. As shown, a ray 406-2 passes through the arc of point 202-1 which indicates the possibility that point 202-2 is behind point 202-1, and therefore is not the closest point to the LiDAR 404 or robot 102. Accordingly, such point 202-2 is not considered herein for the speed limit calculation along the segment dₛ. One skilled in the art will appreciate that a plurality of points 202 can correspond to a particular object detected by sensor units 212, wherein only the closest point to the robot 102 along the given turn partition dictates the speed limit as shown in FIG. 4. By using the arcs 408, the controller 118 may account for error in the position of points 202 caused by imperfect/noisy localization while simultaneously excluding redundant points 202 (such as point 202-2 that is behind point 202-1) from consideration of speed limit calculations. It is appreciated that points 202-3 and 202-4 lie outside the route 402 and also not considered for speed limit calculations while following the trajectory.

In accordance with method 300, the turn partition of the robot 102 for the next segment 410 of route 402 to navigate is determined by the controller 118. In this embodiment, the turn partition includes a slight leftward turn. The maneuver made by the robot 102, when projected onto the map, would intersect either the point 202-1 and/or its arc 408 which could cause a potential collision if the robot 102 continues traveling this along this segment of the route 402. Accordingly, the maximum available distance to stop, dₛ, can be determined. Given the distance available to stop, denoted as dₛ which, in the illustrated position, corresponds with ray 406-1 from a virtual LiDAR, the maximum speed at which the robot 102 may travel along the segment 410 of the route 402 can be calculated. As the robot 102 navigates closer to the point 202-1, dₛ decreases and so too does the maximum speed of the robot 102 until the robot 102 either (i) navigates very close to the point 202-1 at a very slow speed, or (ii) identifies a need to reroute around the point 202-1. In the former case, eventually dₛ shrinks to zero, giving the robot 102 no space to stop (except for a buffer section 502 described below), and the robot 102 speed limit also shrinks to zero. If path adjustments are made in the latter case, method 300 may be utilized again to re-calculate the maximum speed limit for newly added or adjusted portions of the route 402.

FIG. 5 depicts a graph 500 of a maximum speed limit of a robot 102, vₘₐₓ, as a function of distance to the nearest object point, dₛ, according to an exemplary embodiment. The function is a piecewise function containing three sections 502, 504, and 506.

Section 502 includes a speed limit of zero for any value of dₛ in the range. This section 502 may provide a practical safety buffer to account for imperfections in object localization, motor actuation, slippage, and other noises. The practical safety buffer may also be extended for increased precautions by forcing the robot 102 to stop when farther from an object (e.g., in congested or dynamic environments), or contracted if more precise maneuvering closer to objects is desired (e.g., a forklift which needs to precisely maneuver itself into objects). The section 502 may also correspond to the speed limit of robot 102-3 shown in FIG. 6 below which is close enough to an object where the robot 102 cannot advance further without risking collision.

Section 504 is approximated as a linear function wherein the value of the speed limit, vₘₐₓ, increases for larger distances to the nearest object point, dₛ. This increase of the speed limit corresponds with the robot 102 having more space to stop safely, as shown visually by robots 102-1 and 102-2 in FIG. 6. The slope of the section 504 may correspond to the increase in stopping distance of the robot 102 as a function of its initial speed prior to stopping. The slope of section 504 may be determined via empirical measurements of the stopping distance of the robot 102 at various velocities, wherein a best fit line (or, in some embodiments, a quadratic curve if the measurements are non-linear) corresponds to section 504. In some embodiments, the slope of section 504 is further modified by a multiplying parameter which decreases the slope, thereby giving more space for the robot 102 to stop as a safety precaution. That is, the theoretical curve 504 (assuming perfect sensor localization, no slip, and ideal motor actuation) would be of a larger slope than a practical curve which underestimates the speed limit to account for sensor imperfections, wheel slip, and actuator noise as a safety precaution. Such safety precaution may be beneficial to account for unforeseen circumstances, such as the robot 102 stopping on a wet floor and sliding further than the theoretical function 504 would predict, wherein underestimating the slope of the curve would provide an additional safety buffer by ensuring the robot 102 navigates slightly slower than it could under ideal situations which cannot always be assumed.

Lastly, section 506 is a flat portion because the function is limited to a maximum speed of v_{max,safe}. The value of v_{max,safe} corresponds to the maximum speed at which the robot 102 is either capable of navigating or is allowed to navigate given external constraints, such as safety regulations. To illustrate, some robots 102 operate in enclosed areas without humans or objects present, wherein these robots 102 may utilize a higher v_{max,safe} than robots 102 operating in congested spaces with dynamic objects and moving humans. Often these limits are determined by independent standards organizations, such as the International Organization for Standardization (“ISO”), e.g., ISO 10218-1:2011. Further, size or mass of the robot 102 may limit the safe maximum speed limit v_{max,safe} where larger robots 102 may employ a lower v_{max,safe} than smaller robots 102 which are more agile and pose lower risk of damage in collision events. In turn, the controller 118 takes into account all these factors in determining the v_{max,safe}. Lastly, a robot designer may simply desire a slower robot for aesthetic or arbitrary purposes and may set v_{max,safe} to be a value of their subjective desire (e.g., a food delivery robot may set a v_{max,safe} to avoid food spilling).

FIG. 6 depicts various robots 102, e.g., robot 102-1, 102-2, 102-3, 102-4, and 102-5, navigating along various trajectories 604, e.g., trajectories 604-1, 604-2, 604-3, 604-4, and 604-5, nearby a solid object 602, e.g., a wall or barrier to avoid, to illustrate the speed limit calculations shown in FIG. 3-4 and described previously, according to an exemplary embodiment. The robot 102 may (i) identify a maneuver or turn partition to execute next in accordance with the trajectories 604; (ii) identify a closest point to the nearest object, the distance between the robot 102 and the closest point, denoted in FIG. 6 as the available stopping distance dₛ; and (iii) based on a fixed function, such as the function shown in FIG. 5, determine the maximum speed limit of the robot 102 for the turn partition or maneuver based on the possible stopping distance of the robot as a function of robot velocity. Only the speed limits corresponding to the trajectories 604 shown are discussed herein, however it is appreciated that the robot 102 may perform the same calculations for other potential movements such that, in the case of a sudden divergence from the trajectories 604 (e.g., avoiding another object), a new speed limit may be readily determined.

First, robot 102-1 is positioned far from the object 602 and includes a trajectory 604-1 which traverses forward into the object 602. The trajectory 604-1 may include one or multiple segments corresponding to one or multiple executions of the turn partition associated with moving forward. Comparing robot 102-1 to robot 102-2, trajectory 604-2 is of the same shape (i.e., in a forward direction from the robot) and thereby corresponds to movements that correspond to the same turn partition(s) as trajectory 604-1. The magnitude of dₛ₂, however, is less than dₛ₁, thereby providing a shorter stopping distance to stop robot 102-2 compared to robot 102-1. Accordingly, trajectory 604-2 is navigated at a lower maximum velocity than trajectory 604-1. Further, the maximum velocity would continue to decrease as the length of dₛ₁ decreases as the robot 102 moves along the trajectory 604-1 and closer to the object 602.

Robot 102-3 is very close to the object 602 along the trajectory 604-3, which is again a forward movement into the object 602. From this position, sensory noise and localization errors may be sufficiently large such that any error in position is on the same order of magnitude as the length of trajectory 604-3, causing any additional forward movements along 604-3 to pose a high risk of collision. Accordingly, the maximum velocity along this trajectory 604-3 is zero or incredibly small. This trajectory may correspond to section 502 of graph 500 shown in FIG. 5.

As shown by robots 102-1, 102-2, and 102-3, all three robots may navigate along a respective trajectory using the same turn partition as each other with different maximum speeds based on the magnitude of dₛ in accordance with method 300, particularly blocks 304-306. It is appreciated, however, that the three trajectories 604-1, 604-2, and 604-3 are just one of numerous other possible movements the robots 102 could have made. Other possible movements may correspond to different turn partitions and therefore yield a different speed limit in accordance with block 310. For example, consider robot 102-3 turning in place by 90° such that its forward direction is parallel to the object 602 surface, as shown by robot 102-4 and trajectory 604-4. There are no objects along the trajectory 604-4, thereby producing no speed limit maximums based on the method 300 (see section 506 in FIG. 5) for the trajectory 604-4. Robot 102-4 and trajectory 604-4 could be translated left or right along the page to be further or closer to the object 602 without impacting the speed limit along trajectory 604-4 since the object 602 does not pose a risk of collision along this trajectory 604-4. If, at any point, the robot 102-4 were to fully engage its brakes while traveling at maximum speed, there would be no point along trajectory 604-4 where object 602 poses a risk of collision as the robot 102 would travel downwards, parallel to the object 602, during the braking.

Lastly, in some embodiments, the robot 102-5 may be navigating toward the object 602 at an angle and turn to the right (or left in other instances) such that its trajectory 604-5 is parallel to the object 602. The trajectory 604-5 can be discretized into at least two sections, shown by a divider 606: a first section comprising the right-hand turn, and a second section comprising the straight section parallel to the wall.

Each of these sections may correspond to at least one turn partition, where the divider 606 corresponds to the point along the trajectory 604-5 where the turn partition changes. That is, the divider 606 is shown for clarity and is not a designated point at which the controller 118 of the robot 102 decides to change from a first turn partition to a second turn partition. Instead, the controller 118 decides to change the turn partition in accordance with the change in trajectory 604-5. From the illustrated position and while navigating at its maximum speed, if robot 102-5 were to stop suddenly the closest point of potential collision with object 602 is shown via dₛ₅ between the robot 102-5 and object 602. In some embodiments, dₛ₅ is calculated as the tangent ray to the trajectory associated with the right-hand turn partition of the route as shown. Some embodiments may further discretize the right-hand turn into multiple discrete route segments, calculate dₛ₅ for each segment, and perform a speed limit calculation for each segment, however only one curved segment is shown for clarity. Upon reaching the divider 606, the turn partition changes in accordance with the route changing from a curved path to a straight path. While along the straight section, the speed limit is calculated in a manner similar to trajectory 604-4, however there are now no objects along the straight section. As a result, the speed limit increases and the robot 102 may travel faster after crossing the divider 606. In other words, the robot 102 does not do a 90 degree turn or a right angle turn to avoid the object 602 as it travels a route.

It is appreciated that other factors may further limit speed limits of robots 102. For example, safety standards for robots of various sizes may specify maximum speed limits, such as when operating around people or in empty warehouses. Accordingly, in such embodiments, an arc, e.g., arc 502, may be reduced in size relative to a maximum speed limit defined by a safety standard that is lower than a maximum speed limit of the robot 102 determined with method 300. For example, if the calculated speed limit from method 300 exceeds the maximum speed limit set by a safety standard, then the lower speed limit of the two is chosen as the speed limit for the robot 102, in this case the maximum speed limit set by the safety standard. Thus, these safety standards and other factors affecting the maximum speed limit of the robot 102 can be integrated with the speed limit determination of method 300.

FIG. 7A is a functional block diagram of a system configured to determine a speed limit for a robot 102, according to an exemplary embodiment. Turn partitions, as discussed with reference to FIG. 7A, are defined by discrete angular ranges α of a steering column, with 0° corresponding to a forwards movement. A map 702 is provided with updated sensor information and contains a route 704 for the robot 102 to follow. The route 704 is discretized into three partitions, each comprising a length of R_{S1-3}. In this embodiment, the origin point 404 of the virtual LiDAR is located on the front center of the robot 102 on the plane of the map 808. Calculations of the maximum speed limit discussed in reference to FIG. 7A are performed when the robot 102 reaches the beginning of each new turn partition, thereby placing the virtual LiDAR at approximately the start of each partition segment. It is appreciated that the robot 102 does not need to be physically present at each partition to calculate the speed limit in traveling a route including turns, provided the map 702 is up to date, wherein the robot 102 may simulate ranging measurements at the future locations based on the current map 702 data. The virtual LiDAR enables the controller 118 to perform the speed limit calculations described herein prior to the robot 102 physically maneuvering the route.

Using data on the map 702 which includes objects 706-1, 706-2 localized thereon, the controller 118 may determine the closest object point to the virtual LiDAR at various angles with respect to the virtual LiDAR origin. Shown adjacent to the map 702 is a table 708, each row of table 708 corresponds to a virtual LiDAR measurement for a designated angle α with +α defined in the clockwise direction. Stated another way, reading from top to bottom of the table 708 corresponds to reading the virtual LiDAR measurements in a clockwise manner about the sensor origin. The entries highlighted in black correspond to ranges which identify obstacles, such as the objects 706-1 and 706-2 in map 702. One object 706-1, positioned approximately in front of the robot 102 generates entries ranging from approximately 0° to −30°, due in part to its orientation with respect to the robot 102 and the robot's route 704. Another second object 706-2 is positioned such that its height, which is smaller than its width, generates entries at approximately 45° to 50°. White entries describe ranges in which no objects are identified, or ranges in which objects are far enough from the robot 102 that the robot 102 would navigate at the maximum allowable speed (shown in section 606 in FIG. 6 above). That is, from the position of robot 102 shown on map 702, the first object 706-1 would generate a plurality of range measurements, whereas the lower wall 706-2 would generate fewer range measurements due to the perspective of the robot 102 traveling along route 704. Only the closest obstacle per angle α is considered for the speed limit calculation, shown by block 712, which extracts the range to the closest obstacle point per angle α.

The controller 118 may determine the corresponding turn partition for the route segment R_{S1} as shown in block 710 based on the turning angle of the segment R_{S1}. The table 708 of obstacles is filtered in block 712 to remove obstacles which are along the same or similar angle as other obstacles that are further away (shown visually with white entries). An angle is a similar angle if it falls on arc 408 provided to each obstacle point 202, as illustrated in FIG. 4. With these two parameters, the turn partition for the segment Rₛ₁, ranges to nearest objects in table 708, and in conjunction with the speed limit function shown in FIG. 5, the controller 118 may calculate the maximum speed limit for the route segment R_{S1} in block 714. The calculated maximum speed limit is based on the ranges to the nearest objects along the respective turn partitions, wherein the ranges are input into the speed limit function 500 shown in FIG. 5 above.

Using the next turn partition 710 corresponding to the segment R_{S1} in conjunction with the speed limit as a function of a given turn partition determined in 714 block, the controller 118 may output the maximum speed limit for the robot 716 for the next segment R_{S1}. Since the controller 118 has also calculated the maximum speed limit for other turn partitions in block 714, the controller 118 may update the speed limit upon deviating from the route segment (e.g., to avoid an unforeseen object).

According to at least one non-limiting exemplary embodiment, the controller 118 may determine the maximum speed as a function of the turn partitions 714 for every segment d_{S1}, d_{S2}, d_{S3}, and others (not shown for clarity) before navigating to the segments using data on the map 702. The speed limit value for each segment is calculated with respect to the position of the virtual LiDAR at the start of each segment and before traveling that segment by the robot 102. The speed limit values may be different for each segment, wherein the robot 102 upon reaching a new segment may rapidly change its velocity. To avoid sudden changes in speed in between segments, or have the robot 102 experience jerk movements, the controller 118 may interpolate the speed limit values between segments such that each segment gradually increases or decreases the speed limit until it matches the speed limit of the subsequent segment, as further discussed in FIG. 7B next. This produces a smoother velocity over time function of the robot 102 which may be more predictable and comfortable for nearby humans near the robot 102.

FIG. 7B, which consists of three sub-parts (i)-(iii), depicts a robot 102 determining a maximum speed limit for various portions of a route 718, according to an exemplary embodiment. More specifically, FIG. 7B(i) illustrates a route 718 including turns and nearby objects 724-1, 724-2; FIG. 7B(ii) illustrates a table of turn partition 720 corresponding to the route 718; and FIG. 7B(iii) is a graph of the maximum speed limit as a function of distance along the route, according to an exemplary embodiment. Speed limits for the various portions of the route 718 may be calculated in real time as the robot 102 senses and maps the various objects 724 or may be calculated prior to navigation of the route 718 by the robot 102 using sensory data collected previously. In other words, the robot 102 is able to modulate its speed ahead of time based on a preloaded computer readable map with known objects along its path and also modulate its speed in real-time as additional objects are encountered in its traveled path that are new to the environment and not previously provided in the pre-loaded computer readable map. Such dual capability allows the robot 102 to be more versatile in its ever-changing environment around its traveled path. Thereby, reacting to new objects in the environment and adjusting its speed accordingly to new objects in the environment that were not mapped ahead of time in the computer readable map. In turn, the robot 102 can change and modulate its speed around new objects in the same was as known objects pre-loaded onto computer readable maps.

First, in FIG. 7B(i), the route 718 is divided by a plurality of dividers 722 (722-1 to 722-9), each corresponding to a point along the route 718 where the controller 118 of the robot 102 changes from a first turn partition to a different second turn partition. Each divider 722-n corresponds to the start of a route segment R_{Sn}, with n being an integer, wherein each route segment R_{Sn} includes the robot 102 navigating within only one turn partition.

FIG. 7B(ii) places each route segment R_{Sn} into its corresponding turn partition in a turn partition table 720. The turn partition table 720 contains various columns, each column corresponding to a range of turning angles. In some embodiments, the range of turning angles may be parameterized based on the angle of a steering column or steering wheel coupled to, e.g., wheels of the robot 102. The partitions are numbered 1 through 9 and correspond to a range of movements from a −90° sharp left turn to a +90° sharp right turn. In some instances, the partitions may extend beyond 90° turns but the table 720 has been limited for the purposes of discussion and clarity. The turn partitions may each correspond to a set of ranges, such as partitions 1, 2, 3, 7, 8, and 9 corresponding to 15° ranges. Partition 5 may include a range of −5° to +5°, corresponding to relatively straight portions of route. Partitions 4 and 6 may include a range of −15° to −6° and +6° to 15° respectively. It is appreciated that the discretization of the turning angles of the robot 102 as described is for exemplary purposes only and is not intended to be limiting, wherein a different discretization of the turning angles may be utilized instead. Smaller turn partition ranges may increase the calculation time of the method 300 while providing a more granular speed limit which may be beneficial in circumstances with precise motions, but the added cycle time may be a drawback for less precise navigation tasks.

According to at least one non-limiting exemplary embodiment, the range of each turn partition may gradually increase as a function of larger turning angle. During operation, the vast majority of robot 102 movements will be roughly straight-forwards, wherein executing sharp large turns is less common. Accordingly, the range for the turn partitions may be configured such that there are substantially more turn partitions closer to 0° which are of high resolution (i.e., small angular range) and fewer turn partitions closer to 90°. This may enable more precise calculations of speed limits for the majority of maneuvers while reducing computation bandwidth by lowering the resolution of turn partitions for more extreme and rare maneuvers.

With reference to FIG. 7B(i), a first route segment R_{S1} is in the fifth turn partition of the table 720 due to the route segment not including any turns beyond −5° to +5°. A second route segment R_{S2} is in the sixth turn partition due to it containing a very slight right hand turn which is beyond the fifth turn partition range yet below the seventh turn partition range. A third route segment R_{S3} is a sharp right turn and is therefore in the ninth turn partition, a fourth route segment R_{S4} is a slight right turn and is in the sixth partition, and so forth. It is appreciated that the route segments may contain different lengths/distances from each other and are divided based on points along the route where the turning angle of the robot 102 changes into a different turn partition range.

Now that the turn partitions for the route 718 are determined, the speed limits for each route segment are calculated. Although not shown for every route segment for clarity, a few will be discussed in detail. First, consider the divider 722-1 corresponding to the start of route segment R_{S1} in FIG. 7B(i). Route segment R_{S1} is within the fifth turn partition corresponding to turns ranging between [−5°, +5°] since R_{S1} is substantially straight with little to no turning. There are no objects within this angular range that are close enough to at least the starting point 722-1 of the segment R_{S1} that pose a risk of collision to robot 102. Specifically, object 724-2 is far enough such that the resulting speed limit calculation corresponds to section 506 in graph 500 of FIG. 5. In other words, if the robot 102 were to navigate at the maximum allowable speed v_{max,sasfe} the robot 102 would be able to fully stop before contacting the object 724-2, which is the only object along its trajectory. A similar scenario is also shown via a robot 102-4 in FIG. 6 navigating far away from an object 602 or by robot 102-2, provided dₛ₁ is large. As the robot 102 in FIG. 7B(i) navigates the segment R_{S1}, the distance to object 724-2 will decrease and may, eventually, start limiting the maximum speed of the robot 102 corresponding to section 504 in the graph 500 shown in FIG. 5.

The object 724-1 is at approximately a 90° angle from the divider 722-1 and therefore poses no risk of collision in navigating within the turning range of the fifth turn partition. The divider 722-2 corresponding to the start of route segment R_{S2} may be close enough to the object 724-2 to require a reduction in the speed of robot 102, given that the closest point on the object 724-2 lies within the (5°, 15°) range. Divider 722-3 corresponding to the start point of route segment R_{S3} is even closer to the object 724-2 than divider 722-2 is, the distance between point 722-3 and the closest point on object 724-2 shown via a ray 726, and causes the robot 102 to navigate the sharp turn at a reduced speed due to the lowered speed limit.

Route segment R_{S4} corresponds to the sixth turn partition of (5°, 15°) and the only object within this turn partition's angular range is object 724-3. Object 724-3 is further from divider 722-4, corresponding to the start point of route segment R_{S4}, than object 724-2 is from divider 722-3, and thus the robot 102 increases its speed limit to navigate route segment R_{S4}. The speed limit may gradually decrease as the robot 102 approaches closer to object 724-3 along segment R_{S4}. The robot 102 again recalculates its speed limit at route segment R_{S5} since the turn partition has changed. The proximity of divider 722-5, corresponding to the start point of route segment R_{S5}, to object 724-3 being less than the proximity of divider 722-4 to object 724-3. The robot 102 then increases its speed limit while navigating R_{S6} because divider 722-6, corresponding to the start point of route segment R_{S6}, is further from a closest point of an object within the fifth turn partition, which corresponds to object 724-1 and is identified by ray 726-3, than divider 722-5 is to object 724-3.

One may appreciate that the robot 102 changes its maximum velocity substantially between route segments R_{S1} through R_{S6}. To avoid sudden changes in velocity (i.e., the robot 102 suddenly speeding up or slowing down to the new speed limits), the controller 118 may perform the speed limit calculations for each route segment. Subsequently, after calculating the maximum speed for each segment, the controller 118 may assign the maximum speed to each respective divider 722. For instance, the speed limit of R_{S1} is applied to divider 722-1, then adjusted at divider 722-2 for segment R_{S2}, and so forth. This is shown graphically in FIG. 7B(iii) in plot 728, which depicts the speed limits of the robot 102 as a function of distance along the route 718, where the position of dividers 722 along the route are shown with their corresponding maximum velocity determined using the function 500 shown in FIG. 5. A quadradic best fit curve 730, which has a maximum value v_{max,safe}, is applied connecting all dividers 722, thereby yielding the maximum speed limit of the robot 102 as a function of position or distance along the route 718 in a smooth manner, which avoids jittery motions. Alternative methods for interpolating the speed limit values of the points 722 on the graph 728 are considered as well without limitation, wherein the quadradic best fit curve is a non-limiting example. For instance, when changing between R_{Sn} and R_{Sn+1}, the controller 118 may change the speed of the robot 102 in accordance with the change in speed limit within a specified period of time (e.g., 1 second to accelerate/decelerate to the new speed limit).

FIG. 8A depicts a robot 102 attempting to calculate a speed limit for a given route segment 806 in an environment comprising two objects 802 and 804, according to an exemplary embodiment. The route segment 806 is sub-divided into two sections S1 and S2, the two sections S1 and S2 comprise a right turn and a left turn from the robot 102 perspective, respectively, which each fall into different turn partitions.

From the illustrated position, the robot 102 may detect the two objects 802 and 804 in their illustrated position, e.g., using data from various sensor units 112 or having been provided the map at an earlier time. As shown from the three-dimensional perspective, the objects 802 and 804 are of various sizes and shapes. Despite this, both objects 802 and 804 each occupy an approximately rectangular area on the ground which the robot 102 must avoid. Objects which are hanging or suspended above the height of the robot 102 are not considered herein for mapping purposes as these pose no risk of collision with the robot 102. To produce a computer readable map of the environment, the controller 118 aggregates data from sensor unit 112 corresponding to the two objects 802, 804 and projects them onto a mapping plane, which, in this embodiment for a floor-navigating robot 102, is the plane of the floor 808. In some embodiments, other mapping planes may be utilized for a robot 102 navigating a floor without limitation.

In FIG. 8A, the virtual LiDAR is positioned in the front-center of the robot 102 footprint and at the height of the floor place 808 at position 810.

The computer readable map 810 produced due to the environmental scenario shown in FIG. 8A is reproduced in FIG. 8B, according to the exemplary embodiment. Both objects 802 and 804 are represented on the map 810 plane using rectangles of pixels 818 and 820, respectively, each of these pixels being encoded with an “occupied” or “object” (shown in bold black) state indicating the presence of an object at the respective location. As used herein, “objects” may also include other hazards, such as sharp drops in a floor or cliffs/sudden change in vertical height, that pose a risk to the robot 102. Despite a cliff or drop not being itself an object, they are treated in the same manner as physical objects, e.g., 802, wherein the robot 102 avoids navigating over them and calculates speed limits with respect to these hazards in the same manner as physical objects. In such cases, pixels corresponding to sharp drops or cliffs are treated the same as pixels representing physical objects to avoid as it relates to speed limit calculations and path planning relevant to the present disclosure. Other pixel states may be present in some non-limiting exemplary embodiments, such as costs if the map is a cost map, wherein the use of only the illustrated pixel states is not intended to be limiting. According to at least one non-limiting exemplary embodiment, occupied pixels may be assigned by user input rather than in response to a detected obstacle, such as to implement a “keep out” or “no go” zone preventing robotic navigation therein at a user request, wherein such pixels are also treated in the same manner for path planning and speed limit calculations as pixels corresponding to other objects and hazards.

A plurality of rays 812 corresponding to the closest points to nearest object pixels as detected by the virtual LiDAR 810 are shown in FIG. 8B. Dashed rays 814 indicate the closest geometric point on objects for all possible turn partitions which, in this example, do not correspond to the route 806 been executed. These distances and corresponding speed limits are calculated in case, e.g., the robot 102 needs to deviate from the route due to unforeseen objects.

For the first segment S1 of the route, the controller 118 performs method 300 for all available turn partitions from its illustrated position in FIG. 8A which is represented by its footprint 816 in FIG. 8B on the map 810. The solid ray 812 extending from the virtual LiDAR origin 810 correspond to the turn partition associated with the right-ward turn in segment S1. Accordingly, these distances dictate the speed limit in accordance with method 300 and the speed limit function shown and described in FIG. 6. In some embodiments, the speed limit remains constant for each discrete route segment S1, S2, and so forth, wherein an interpolation may be applied to ensure smooth movements. In other embodiments, the controller 118 may re-calculate the speed limit as the robot 102 moves closer to the object 804 on the map. Once the right-hand turn in segment S1 has been executed, the virtual LiDAR origin 810 is positioned at the start of segment S2. From this position, the closest object to virtual LiDAR is object 802, however such point is far beyond the turn partition of the left-hand turn and therefore is not utilized in the speed limit calculation for segment S2.

The controller 118 still utilizes other rays, such as ray 814 to object 802, to calculate speed limits for other turn partitions (e.g., a straight and forward partition following S1). Consider the robot 102 over-turning left, causing it to approach the object 804. It is appropriate then, upon identifying the robot 102 has over-turned (e.g., via gyroscopic or other sensor data) during the next control cycle, to utilize the proper turn partition and speed limit corresponding to the over-turn movement.

Advantageously, the present disclosure enables robots 102 to rapidly identify and adapt their maximum speed in accordance with dynamics of their environment without a requirement of prior mapping data of the environment in order to adjust to and react to new objects presented in its environment and that are in its traveled path that were not previously identified in the computer readable map. The robot 102 can change and modulate its speed around new objects in the same was as known objects pre-loaded onto computer readable maps. The pre-computing of speed limits using sensor data and maps collected previously reduces the real-time calculations to only scenarios where new objects (e.g., moving objects) are sensed. This allows robots 102 to operate at their maximum (safe) speed which can improve task execution time and efficiency. For example, a robot 102 can drive down an empty hallway at a first time quickly, but later when the hallway is occupied by people, the robot 102 would drive slower without having prior knowledge of the congestion in the hallway. Further, the speed limit calculation method herein improves safety by naturally reducing the speed limit as a function of risk (i.e., distance to potential collisions). Lastly, the present method may be implemented using look-up tables for (i) selecting the turn partition of the route, or (ii) selecting a different speed limit for a different turn partition in response to deviations from the route, which allow for rapid speed limit calculation and updating.

The controller 118 may be responsible for determining a maximum speed limit for various portions of a route. This may involve calculating speed limits for each route segment, which can be based on the proximity of the robot 102 to objects such as 724-1, 724-2, and 724-3. The controller 118 may segment the route into a plurality of route segments, each corresponding to a specific turn partition. The proximity of objects within these partitions may influence the calculated speed limits, potentially affecting the robot's navigation speed. The robot 102 may navigate these segments while considering the calculated speed limits to ensure safe operation. The controller 118 may assign these speed limits to respective dividers, which may correspond to the start of each route segment. The calculated speed limits may be applied to the dividers, allowing the robot 102 to adjust its speed as it progresses along the route. The controller 118 may utilize a fitting function, such as a quadratic best fit curve, to connect the dividers and yield a continuous maximum speed limit as a function of the robot's position along the route. This approach may help in avoiding sudden changes in velocity, thereby ensuring smooth navigation. The system may be configured to adapt to various route conditions, potentially enhancing the robot's ability to navigate safely and efficiently.

The route 718 may be divided by a plurality of dividers 722, which can correspond to points along the route where a turning angle of the robot changes between predefined turn partition ranges. This segmentation may allow for the route to be organized into distinct segments, each potentially corresponding to a specific turn partition. The dividers 722 may serve as markers that delineate the start of each route segment, thereby facilitating the segmentation process. The segmentation of the route may be important for determining the speed limits for each segment, as it may allow the controller to calculate speed limits based on the proximity of the robot to objects within an angular range of a turn partition corresponding to each route segment. The dividers 722 may be assigned the calculated speed limits, which can then be applied to yield a continuous maximum speed limit as a function of the position of the robot along the route. The segmentation process may be essential for ensuring that the robot navigates safely along the route, as it may allow for the calculation of speed limits that take into account the potential risk of collision with objects. The segmentation of the route may also facilitate the application of a fitting function, such as a quadratic best fit curve, which can connect the dividers to yield a smooth and continuous maximum speed limit. This process may help in avoiding sudden changes in velocity, thereby ensuring a smooth navigation experience for the robot.

The graph 500 may be utilized to depict the speed limits as a function of distance along the route. This depiction may be achieved through the use of a quadratic best fit curve 730, which may be applied to connect all dividers 722. The plot 728 may serve to illustrate the speed limits of the robot 102 as a function of distance along the route 718. The quadratic best fit curve 730 may yield the maximum speed limit of the robot 102 in a smooth manner, potentially avoiding jittery motions. The quadratic best fit curve may be considered a non-limiting example, and alternative methods for interpolating the speed limit values of the points 722 on the graph 728 may also be considered. The controller 118 may change the speed of the robot 102 in accordance with the change in speed limit within a specified period of time, such as one second to accelerate or decelerate to the new speed limit. The visualization of speed limits may be facilitated by the graph 500, quadratic best fit curve 730, and plot 728, which may collectively provide a comprehensive representation of the speed limits as a function of distance along the route.

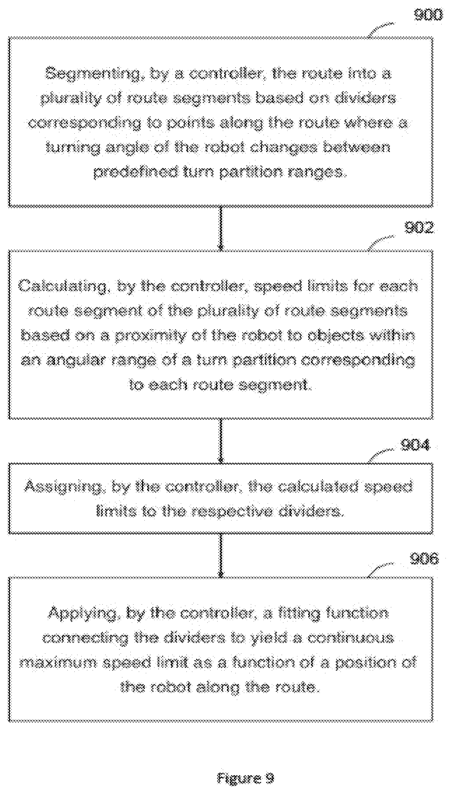

FIG. 9 is a flowchart illustrating a method in step 900 for segmenting a route into multiple route segments by a controller 118, according to an embodiment. At step 900, the controller may segment the route into a plurality of route segments based on dividers corresponding to points along the route where a turning angle of the robot changes between predefined turn partition ranges. Each divider may correspond to the start of a respective route segment, and each route segment may include the robot navigating within only one turn partition. The segmentation process may involve the controller 118 identifying specific points along the route where the robot's turning angle changes, thereby necessitating a transition from one turn partition to another.

This segmentation may be important for determining the appropriate speed limits for each segment, as it allows the controller 118 to account for the proximity of the robot to objects and the associated risk of collision. The dividers may serve as reference points for assigning calculated speed limits, ensuring that the robot 102 navigates safely and efficiently along the route. The segmentation may also facilitate the application of a fitting function, such as a quadratic best fit curve, to yield a continuous maximum speed limit as a function of the robot's position along the route. This approach may enable smooth transitions between speed limits, reducing the likelihood of abrupt changes in velocity and enhancing the overall navigation experience. The controller's 118 ability to change from a first turn partition to a different second turn partition may further optimize the robot's navigation by adapting to varying route conditions and ensuring that the robot maintains a safe and efficient speed throughout its journey.

In the context of determining speed limits for a robot 102 navigating a route, the process may involve calculating speed limits for each route segment based on the proximity of the robot to objects within an angular range of a turn partition corresponding to each route segment. The controller 102 may play a significant role in this calculation, potentially considering the risk of collision posed by nearby objects, which may affect the calculated speed limits. The robot may determine the maximum speed limit to navigate safely along the route, ensuring that it can stop before contacting any object along its trajectory. The controller may assess the proximity of objects such as 724-1, 724-2, and 724-3 to the robot 102, and adjust the speed limits accordingly. The robot's navigation may be influenced by the angular range of the turn partition, which may dictate the speed limit adjustments necessary for safe navigation. The process may involve a dynamic assessment of the robot's position relative to objects, allowing for real-time adjustments to the speed limits to maintain safety and efficiency in navigation.

At step 904, the controller 118 may assign the calculated speed limits to the respective dividers. This process may involve the controller associating each calculated speed limit with a specific divider, which corresponds to a point along the route where the robot's turning angle changes between predefined turn partition ranges. The dividers may serve as markers that delineate the start of each route segment, and the calculated speed limits may be applied to these dividers to ensure that the robot navigates each segment at an appropriate speed. The assignment of speed limits to dividers may be important for maintaining a continuous and smooth navigation path for the robot, as it transitions from one route segment to another. The controller 118 may utilize the calculated speed limits to adjust the robot's speed dynamically, ensuring safe and efficient navigation along the route. This step may be part of a broader method for determining and applying speed limits for a robot navigating a route, which may include segmenting the route, calculating speed limits based on proximity to objects, and applying a fitting function to yield a continuous maximum speed limit. The assignment of speed limits to dividers may be a key component in achieving a seamless and safe navigation experience for the robot.

In the context of determining and applying speed limits for a robot navigating a route, the process may involve the application of a fitting function by the controller to connect dividers, as noted in step 906, thereby yielding a continuous maximum speed limit as a function of the robot's position along the route. The fitting function may be a quadratic best fit curve, which is applied to ensure a smooth transition of speed limits across different route segments. This approach may help in avoiding abrupt changes in velocity, which could otherwise lead to instability in the robot's movement. The predefined turn partition ranges may gradually increase as a function of larger turning angles, allowing for more precise speed limit calculations in areas requiring finer control. These ranges may be configured such that there are more turn partitions closer to 0° with smaller angular ranges, and fewer partitions closer to 90° with larger angular ranges, optimizing the balance between precision and computational efficiency. The controller may change from a first turn partition to a different second turn partition to navigate different route segments, ensuring that the robot adapts its speed according to the specific requirements of each segment. This method may facilitate safe and efficient navigation by the robot along the route, taking into account the varying conditions and potential obstacles encountered.

It will be recognized that while certain aspects of the disclosure are described in terms of a specific sequence of steps of a method, these descriptions are only illustrative of the broader methods of the disclosure, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the disclosure disclosed and claimed herein.

While the above detailed description has shown, described, and pointed out novel features of the disclosure as applied to various exemplary embodiments, it will be understood that various omissions, substitutions, and changes in the form and details of the device or process illustrated may be made by those skilled in the art without departing from the disclosure. The foregoing description is of the best mode presently contemplated of carrying out the disclosure. This description is in no way meant to be limiting, but rather should be taken as illustrative of the general principles of the disclosure. The scope of the disclosure should be determined with reference to the claims.

While the disclosure has been illustrated and described in detail in the drawings and foregoing description, such illustration and description are to be considered illustrative or exemplary and not restrictive. The disclosure is not limited to the disclosed embodiments. Variations to the disclosed embodiments and/or implementations may be understood and effected by those skilled in the art in practicing the claimed disclosure, from a study of the drawings, the disclosure and the appended claims.

It should be noted that the use of particular terminology when describing certain features or aspects of the disclosure should not be taken to imply that the terminology is being re-defined herein to be restricted to include any specific characteristics of the features or aspects of the disclosure with which that terminology is associated. Terms and phrases used in this application, and variations thereof, especially in the appended claims, unless otherwise expressly stated, should be construed as open ended as opposed to limiting. As examples of the foregoing, the term “including” should be read to mean “including, without limitation,” “including but not limited to,” or the like; the term “comprising” as used herein is synonymous with “including,” “containing,” or “characterized by,” and is inclusive or open-ended and does not exclude additional, unrecited elements or method steps; the term “having” should be interpreted as “having at least;” the term “such as” should be interpreted as “such as, without limitation;” the term ‘includes” should be interpreted as “includes but is not limited to;” the term “example” is used to provide exemplary instances of the item in discussion, not an exhaustive or limiting list thereof, and should be interpreted as “example, but without limitation;” adjectives such as “known,” “normal,” “standard,” and terms of similar meaning should not be construed as limiting the item described to a given time period or to an item available as of a given time, but instead should be read to encompass known, normal, or standard technologies that may be available or known now or at any time in the future; and use of terms like “preferably,” “preferred,” “desired,” or “desirable,” and words of similar meaning should not be understood as implying that certain features are critical, essential, or even important to the structure or function of the present disclosure, but instead as merely intended to highlight alternative or additional features that may or may not be utilized in a particular embodiment. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. The terms “about” or “approximate” and the like are synonymous and are used to indicate that the value modified by the term has an understood range associated with it, where the range may be ±20%, ±15%, ±10%, ±5%, or ±1%. The term “substantially” is used to indicate that a result (e.g., measurement value) is close to a targeted value, where close may mean, for example, the result is within 80% of the value, within 90% of the value, within 95% of the value, or within 99% of the value. Also, as used herein “defined” or “determined” may include “predefined” or “predetermined” and/or otherwise determined values, conditions, thresholds, measurements, and the like.

What is claimed is:

1. A system, comprising:
a memory comprising computer readable instructions stored thereon; and
a controller configured to execute the computer readable instructions to:
receive data from a plurality of sensors coupled to a robot, the data comprising a plurality of points corresponding to obstacles in an environment of the robot;
determine, for each turn partition of a plurality of turn partitions, a distance to a nearest point of each of one or more obstacles located in each respective turn partition;
determine a turn partition of the plurality of turn partitions to execute in accordance with a portion of a route for the robot to follow, wherein the portion of the route comprises a turn within a range corresponding to the turn partition;
determine a speed limit for the robot for the portion of the route based on the distance to the nearest point of each of the one or more obstacles located in the turn partition; and
assign a maximum speed to the robot based on a corresponding speed limit of the turn partition.

2. The system of claim 1, wherein each turn partition comprises a plurality of discretized motions that the robot performs when navigating the environment according to a respective turn partition.

3. The system of claim 1, wherein, upon determining the nearest point of each of the one or more obstacles, the controller is further configured to execute the computer readable instructions to:
determine a nearest LiDAR point of each of the one or more obstacles with respect to a virtual LiDAR, the virtual LiDAR comprising an origin point from which ranges to the plurality of points measured by the plurality of sensors are defined with respect to, wherein each nearest LiDAR point comprises an angle defined about the origin point; and
extend each nearest LiDAR point by a threshold angular distance in both a clockwise and a counter-clockwise direction from the origin point of the virtual LiDAR to generate a nearest point arc for each nearest LiDAR point, wherein each nearest point arc comprises a plurality of points.

4. The system of claim 3, wherein, upon determining the nearest point of the obstacles, the controller is further configured to execute the computer readable instructions to:
exclude at least a portion of the plurality of points of one or more of the nearest point arcs corresponding to points that are behind other nearest point arcs with respect to the origin point.

5. The system of claim 1, wherein, upon determining the speed limit, the controller is further configured to execute the computer readable instructions to:
discretize the route into a plurality of sequential route sections, wherein each route section corresponds to a different turn partition of the plurality of turn partitions from a prior route section;
determine a speed limit for each route section based on the distance to the nearest point of one or more objects in each route section;
interpolate the speed limit for each route section between each point along a designated route to determine a speed limit as a function of distance along the route; and
navigate at or below the speed limit as a function of distance along the route.

6. The system of claim 1, wherein the maximum speed of the robot is less than a threshold speed.

7. The system of claim 1, wherein, upon assigning the maximum speed, the controller is further configured to execute the computer readable instructions to:
evaluate two or more speed limits with respect to two or more different modes of stopping the robot, wherein different modes of stopping correspond to different stopping distances, and
adjusting speed limits of the robot in real-time based on new objects identified along the route traveled by the robot, the new objects not being pre-loaded onto a computer readable map of the environment, the computer readable map being uploaded onto the robot prior to navigation of the robot along the route.

8. A method of a maneuvering a robot, comprising:
receiving, by a controller coupled to a robot, data from a plurality of sensors, the data comprising a plurality of points corresponding to obstacles in an environment of the robot;
determining, by the controller, for each turn partition of a plurality of turn partitions, a distance to a nearest point of the obstacles located in each respective turn partition;
determining, by the controller, a turn partition of the plurality of turn partitions to execute in accordance with a portion of a route for the robot to follow, wherein the portion of the route comprises a turn within a range corresponding to the turn partition;
determining, by the controller, a speed limit for the robot for the portion of the route based on the distance to the nearest point of each of the obstacles located in the turn partition; and
assigning, by controller, a maximum speed of the robot based on a corresponding speed limit of the turn partition.

9. The method of claim 8, wherein each turn partition comprises a plurality of discretized motions the robot performs when navigating the environment according to the respective turn partition.

10. The method of claim 8, further comprising:
determining, by the controller, a nearest LiDAR point of each of the obstacles with respect to a virtual LiDAR, the virtual LiDAR comprising an origin point from which ranges to the plurality of points measured by the plurality of sensors are defined with respect to, wherein each nearest LiDAR point comprises an angle defined about the origin point; and
extending, by the robot, each nearest LiDAR point by a threshold angular distance in both a clockwise and a counter-clockwise direction from the origin point of the virtual LiDAR to generate a nearest point arc for each nearest LiDAR, wherein each nearest point arc comprises a plurality of points.

11. The method of claim 10, further comprising:
excluding at least a portion of the plurality of points of one or more of the nearest point arcs corresponding to points that are behind other nearest point arcs with respect to the origin point.

12. The method of claim 8, further comprising:
discretizing, by the controller, the route into a plurality of sequential route sections, wherein each route section corresponds to a different turn partition of the plurality of turn partitions from a prior route section;
determining, by the controller, a speed limit for each route section based on the distance to the nearest point of one or more objects in each route section;
interpolating, by the controller, the speed limits for each route section between each point along a designated route to determine a speed limit as a function of distance along the route; and
navigating, by the controller, at or below the speed limit as a function of distance along the route.

13. The method of claim 8, wherein the maximum speed of the robot is less than a threshold speed.

14. The method of claim 8, further comprising:
evaluating, by the controller, two or more speed limits with respect to two or more different modes of stopping the robot, wherein the different modes of stopping correspond to different stopping distances; and
adjusting speed limits of the robot in real-time based on new objects identified along the route traveled by the robot, the new objects not being pre-loaded onto a computer readable map of the environment, the computer readable map being uploaded onto the robot prior to navigation of the robot along the route.

15. A non-transitory computer readable storage medium comprising computer readable instructions stored thereon that, when executed by one or more controllers of a robot, cause the robot to:
receive sensor data from a plurality of sensors, the sensor data comprising a plurality of points corresponding to obstacles in an environment of the robot;
determine, for each turn partition of a plurality of turn partitions, a distance to a nearest point of each of one or more obstacles located in each respective turn partition;
determine a turn partition of the plurality of turn partitions to execute in accordance with a portion of a route for the robot to follow, wherein the portion of the route comprises a turn within a range corresponding to the turn partition;
determine a speed limit for the robot for the portion of the route based on the distance to the nearest point of each of the one or more obstacles located in a selected turn partition; and
assign a maximum speed of the robot based on a corresponding speed limit of the selected turn partition.

16. The non-transitory computer readable storage medium of claim 15, wherein each turn partition comprises a plurality of discretized motions the robot performs when navigating the environment according to the respective turn partition.

17. The non-transitory computer readable storage medium of claim 15, wherein the computer readable instructions further cause the robot to:
determine a nearest LiDAR point of each of the one or more obstacles with respect to a virtual LiDAR, the virtual LiDAR comprising an origin point from which ranges to the plurality of points measured by the plurality of sensors are defined with respect to, wherein each nearest LiDAR point comprises an angle defined about the origin point; and
extend each nearest LiDAR point by a threshold angular distance in both a clockwise and a counter-clockwise direction from the origin point of the virtual LiDAR to generate a nearest point arc for each nearest LiDAR point, wherein each nearest point arc comprises a plurality of points.

18. The non-transitory computer readable storage medium of claim 17, wherein the computer readable instructions further cause the robot to:
exclude at least a portion of the plurality of points of one or more of the nearest point arcs corresponding to points that are behind other nearest point arcs with respect to the origin point.

19. The non-transitory computer readable storage medium of claim 15, wherein the computer readable instructions further cause the robot to:
discretize the route into a plurality of sequential route sections, wherein each route section corresponds to a different turn partition of the plurality of turn partitions from a prior route section;
determine a speed limit for each route section based on the distance to the nearest point of one or more objects in each route section;
interpolate the speed limits for each route section between each point along a designated route to determine a speed limit as a function of distance along the route; and
navigate at or below the speed limit as a function of distance along the route.

20. The non-transitory computer readable storage medium of claim 15, wherein the computer readable instructions further cause the robot to:
evaluate two or more speed limits with respect to two or more different modes of stopping the robot, wherein the different modes of stopping correspond to different stopping distances; and
adjusting speed limits of the robot in real-time based on new objects identified along the route traveled by the robot, the new objects not being pre-loaded onto a computer readable map of the environment, the computer readable map being uploaded onto the robot prior to navigation of the robot along the route.
